(19) United States
(12) Patent Application Publication
(10) Pub. No.: US 2025/0310836 A1
(43) Pub. Date: Oct. 2, 2025

(54) METHOD AND APPARATUS FOR SELF-OPTIMIZATION IN WIRELESS NETWORKS

(71) Applicant: SAMSUNG ELECTRONICS CO., LTD., Suwon-si, Gyeonggi-do (KR)

(72) Inventors: Aby Kanneath ABRAHAM, Bangalore (IN); Vinay Kumar SHRIVASTAVA, Bangalore (IN); Sriganesh RAJENDRAN, Bangalore (IN)

(21) Appl. No.: 18/881,211

(22) PCT Filed: Jul. 6, 2023
(86) PCT No.: PCT/KR2023/009604

§ 371 Date: Jan. 3, 2025

(30) Foreign Application Priority Data
Jul. 6, 2022 (IN) 202241038836
May 30, 2023 (IN) 202241038836

(51) Int. Cl. H04W 36/00; H04W 36/24; H04W 84/04

(52) U.S. Cl. CPC H04W 36/0022; H04W 36/0058; H04W 36/249; H04W 84/042

(57) ABSTRACT

The disclosure relates to a 5G or 6G communication system for supporting a higher data transmission rate. The method includes detecting whether a threshold configured for a SHR for an inter-RAT handover is satisfied when at least one of a first RRC message includes the threshold for the SHR and a mobility command includes the threshold for the SHR for the inter-RAT handover, and logging or skipping logging of the SHR for the inter-RAT handover when the threshold configured for the SHR for the inter-RAT handover is satisfied. In another embodiment, the method includes detecting a RLF during or after performing the inter-RAT handover when the mobility command includes the voice fallback indication, and logging an indicator indicating the mobility is for the voice fallback in a RLF report for the RLF during or after performing the inter-RAT handover.

### TECHNICAL FIELD

The disclosure generally relates to the field of wireless communication. More particularly, the disclosure relates to a terminal and a communication method thereof in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

This disclosure relates to wireless communication networks, and more particularly to a terminal and a communication method thereof in a wireless communication system.

In accordance with an aspect of the disclosure, a method for self-optimization in a wireless network includes receiving, by a UE, a first RRC message. Further, the method includes receiving, by the UE, a mobility command for an inter-RAT handover. Further, the method includes triggering, by the UE, the inter-RAT handover from a source RAT to a target RAT in the wireless network upon receiving the mobility command. Further, the method includes determining, by the UE, whether at least one of the first RRC message includes a threshold for a Successful Handover Report (SHR) for the inter-RAT handover', and the mobility command includes at least one of the threshold for the SHR for the inter-RAT handover, and a voice fallback indication'. In an embodiment, the method includes detecting whether the threshold configured for the SHR for the inter-RAT handover is satisfied when at least one of the first RRC message includes the threshold for the SHR and the mobility command includes the threshold for the SHR for the inter-RAT handover, and logging or skipping logging of the SHR for the inter-RAT handover when the threshold configured for the SHR for the inter-RAT handover is satisfied. In another embodiment, the method includes detecting a RLF during or after performing the inter-RAT handover when the mobility command includes the voice fallback indication, and logging an indicator indicating the mobility is for a voice fallback in a RLF report for the RLF during or after performing the inter-RAT handover.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a wireless network for self-optimization, according to the embodiments as disclosed herein;

FIG. 2 shows various hardware components of a UE, according to the embodiments as disclosed herein;

FIG. 3 shows various hardware components of a network apparatus, according to the embodiments as disclosed herein;

FIG. 4 is a flow chart illustrating a method, implemented by the UE, for self-optimization in the wireless network, according to the embodiments as disclosed herein;

FIG. 5 is a flow chart illustrating a method, implemented by the network apparatus, for self-optimization in the wireless network, according to the embodiments as disclosed herein;

FIG. 6 is a flow diagram illustrating a step by step operation of an inter-RAT SHR reporting, according to the embodiments as disclosed herein;

FIG. 7 is a sequence diagram illustrating a step by step operation a voice fallback indication in a SHR reporting, according to the embodiments as disclosed herein;

FIG. 8 is a sequence diagram illustrating a step by step operation a voice fallback indication RLF reporting, according to the embodiments as disclosed herein;

FIG. 9 is a sequence diagram illustrating a step by step operation a voice fallback indication CEF reporting, according to the embodiments as disclosed herein;

FIG. 10 is a sequence diagram illustrating a step by step operation a voicefall-backredirection reporting, according to the embodiments as disclosed herein;

FIG. 11 is a flow chart illustrating a method for handling of mobility information with voice fallback, while handling a self-optimization in the wireless network, according to the embodiments as disclosed herein;

FIG. 12 is a flow chart illustrating a scenario of logging of return from voice fallback indication, while handling a self-optimization in the wireless network, according to the embodiments as disclosed herein;

FIG. 13 is a sequence diagram illustrating a step by step operation of informing return from voice fallback to the UE, according to the embodiments as disclosed herein;

FIG. 14 illustrates various hardware components of a UE, according to the embodiments as disclosed herein; and

FIG. 15 illustrates various hardware components of a base station according to the embodiments as disclosed herein.

Throughout the drawings, it should be noted that like reference numbers are used to depict the same or similar elements, features, and structures.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

Accordingly, the embodiment herein is to provide a method for self-optimization in a wireless network. The method includes receiving, by a UE, a first RRC message. Further, the method includes receiving, by the UE, a mobility command for an inter-RAT handover. Further, the method includes triggering, by the UE, the inter-RAT handover from a source RAT to a target RAT in the wireless network upon receiving the mobility command. Further, the method includes determining, by the UE, whether at least one of the first RRC message includes a threshold for a Successful Handover Report (SHR) for the inter-RAT handover', and the mobility command includes at least one of the threshold for the SHR for the inter-RAT handover, and a voice fallback indication'. In an embodiment, the method includes detecting whether the threshold configured for the SHR for the inter-RAT handover is satisfied when at least one of the first RRC message includes the threshold for the SHR and the mobility command includes the threshold for the SHR for the inter-RAT handover, and logging or skipping logging of the SHR for the inter-RAT handover when the threshold configured for the SHR for the inter-RAT handover is satisfied. In another embodiment, the method includes detecting a RLF during or after performing the inter-RAT handover when the mobility command includes the voice fallback indication, and logging an indicator indicating the mobility is for a voice fallback in a RLF report for the RLF during or after performing the inter-RAT handover.

In an embodiment, logging for the inter-RAT handover when the threshold configured for the SHR for the inter-RAT handover is performed when the mobility command is a NR RRC message MobilityFromNRCommand including targetRAT-Type Information Element (IE) as E-UTRA.

In an embodiment, the method includes receiving, by the UE, a UE capability request message from a network apparatus. Further, the method includes sending, by the UE, a UE capability response message to the network apparatus, where the UE capability response message includes at least one of: a support of the UE for storage and delivery of the SHR for the inter-RAT handover from at least one of the NR to the E-UTRA and the E-UTRA to the NR, and a support of the UE for storing and reporting information about the voice fallback.

In an embodiment, the method includes sending, by the UE, at least one of an indication of availability of the SHR for the inter-RAT handover when at least one of the first RRC message includes the threshold for the SHR and the mobility command includes the threshold for the SHR for the inter-RAT handover or an indication of availability of the RLF report when the mobility command includes the voice fallback indication. Further, the method includes sending, by the network apparatus, a UE information request message to the UE. Further, the method includes receiving, by the network apparatus, a UE information response message from the UE. The UE information response message includes at least one of the SHR for the inter-RAT handover or the RLF report including information about the voice fallback for the inter-RAT handover.

In an embodiment, logging the SHR for the inter-RAT handover includes storing at least one of a PLMN identifier or a SNPN identifier, a cell identifier of a source cell and a target cell, measurement results of source NR cell and inter-RAT and intra-RAT neighbours, random access related information, location information, user plane interruption information, a C-RNTI in the source cell and a Cell Radio Network Temporary Identifier (C-RNTI) in the target cell, and a time taken for performing the inter-RAT handover.

In an embodiment, the measurement results of the source NR cell and the inter-RAT and intra-RAT neighbours includes the measurements for the measurement objects configured by the source PCell or any previous PCell. In the NR, measurement objects for NR neighbors may be configured through measObjectNR IE and the measurement objects for NR neighbors may be configured through measObjectEUTRA. If the UE has received measObjectNR or measObjectEUTRA while it was connected to source PCell or any previous NR PCell, UE includes the measurements in Inter-RAT SHR.

In an embodiment, the method includes releasing, by the UE, the threshold for the SHR for the inter-RAT handover during at least one of an initiation of RRC connection Resume procedure, and an initiation of RRC Reestablishment procedure

In an embodiment, logging the SHR for the inter-RAT handover is skipped when the mobility command is received while a NR timer T316 is running. In an embodiment, if the UE received MobilityFromNRCommand including targetRAT-Type as EUTRA while T316 is running (i.e., in response to sending MCGFailureInformation RRC message), UE may skip logging and reporting the Inter-RAT SHR.

In an embodiment, the first RRC message is one of a RRC Reconfiguration message or a RRC Resume message.

Accordingly, the embodiment herein is to provide a method for self-optimization in wireless network. The method includes sending, by the network apparatus, a first RRC message to the UE. The first RRC message includes a threshold for a SHR for the inter-RAT handover. Further, the method includes sending, by the network apparatus, a mobility command for the inter-RAT handover to the UE. The mobility command includes at least one of the threshold for the SHR for the inter-RAT handover, and a voice fallback indication. Further, the method includes receiving, by the network apparatus from the UE, at least one of an indication of availability of the SHR for the inter-RAT handover when at least one of the first RRC message includes the threshold for the SHR and the mobility command includes the threshold for the SHR for the inter-RAT handover or an indication of availability of an RLF report from the UE when the mobility command includes the voice fallback indication. Further, the method includes sending, by the network apparatus, a UE information request message to the UE. Further, the method includes receiving, by the network apparatus, a UE information response message from the UE. The UE information response message includes at least one of the SHR for the inter-RAT handover or the RLF report including information about the voice fallback for the inter-RAT handover.

In an embodiment, the method includes sending, by the network apparatus, a UE capability request message to the UE. Further, the method includes receiving, by the network apparatus, a UE capability response message from the UE. The UE capability response message includes at least one of: a support of the UE for storage and delivery of the SHR for at least one of the inter-RAT handover from at least one of a NR to an E-UTRA and the E-UTRA to the NR, and a support of the UE for storing and reporting information about the voice fallback.

In an embodiment, the RLF report includes an indicator indicating a RLF occurred during or after performing for the inter-RAT handover for the voice fallback.

In an embodiment, the UE considers the mobility from NR procedure for emergency services fallback, for e.g. as specified in TS 23.502, as also as voice fallback. All the embodiments performed by the UE and the network when the mobility command including voice fallback indication are applicable for this scenario also.

Accordingly, the embodiment herein is to provide a UE for self-optimization in a wireless network. The UE includes a self-optimization controller communicatively coupled to a memory and a processor. The self-optimization controller is configured to receive a first RRC message. Further, the self-optimization controller is configured to receive a mobility command for an inter-RAT handover. Further, the self-optimization controller is configured to trigger the inter-RAT handover from a source RAT to a target RAT in the wireless network upon receiving the mobility command. Further, the self-optimization controller is configured to determine whether at least one of the first RRC message includes a threshold for a SHR for the inter-RAT handover', and the mobility command includes at least one of the threshold for the SHR for the inter-RAT handover, and a voice fallback indication'. In an embodiment, the self-optimization controller is configured to detect whether the threshold configured for the SHR for the inter-RAT handover is satisfied when at least one of the first RRC message includes the threshold for the SHR and the mobility command includes the threshold for the SHR for the inter-RAT handover, and logging or skipping logging of the SHR for the inter-RAT handover when the threshold configured for the SHR for the inter-RAT handover is satisfied. In another embodiment, the self-optimization controller is configured to detect a RLF during or after performing the inter-RAT handover when the mobility command includes the voice fallback indication, and logging an indicator indicating the mobility is for a voice fallback in a RLF report for the RLF during or after performing the inter-RAT handover.

Accordingly, the embodiment herein is to provide a network apparatus for self-optimization in a wireless network. The network apparatus includes a self-optimization controller communicatively coupled to a memory and a processor. The self-optimization controller is configured to send a first RRC message to the UE. The first RRC message includes at least one threshold for a SHR for the inter-RAT handover. Further, the self-optimization controller is configured to send a mobility command for the inter-RAT handover to the UE. The mobility command includes at least one of the threshold for the SHR for the inter-RAT handover, and a voice fallback indication. Further, the self-optimization controller is configured to receive at least one of an indication of availability of the SHR for the inter-RAT handover from the UE, when at least one of the first RRC message includes the threshold for the SHR and the mobility command includes the threshold for the SHR for the inter-RAT handover or an indication of availability of an RLF report from the UE when the mobility command includes the voice fallback indication. Further, the self-optimization controller is configured to send a UE information request message to the UE. Further, the self-optimization controller is configured to receive a UE information response message from the UE, where the UE information response message includes at least one of the SHR for the inter-RAT handover or the RLF report including information about the voice fallback for the inter-RAT handover.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The principal object of the embodiments herein is to provide a method, a UE, and a network apparatus for self-optimization in a wireless network.

Another object of the embodiments herein is to perform the SON for inter-RAT mobility from a LTE (and UMTS) to a NR and vice versa.

Another object of the embodiments herein is to perform the SON for inter-RAT mobility from the NR to the LTE, the LTE to the NR and the SRVCC from the NR to a 3G UMTS.

Another object of the embodiments herein is to perform the SON for inter-RAT mobility during a voice fallback from the NR to the LTE through a handover or a redirection.

Another object of the embodiments herein is to perform the SON for the inter-RAT mobility returning to the NR from the LTE after voice fallback when a voice call is finished.

Another object of the embodiments herein is to perform logging and reporting of inter-RAT successful handover reports (SHR) and the logging and reporting of voice fallback from the NR through the handover or the redirection.

Inter-RAT mobility in a NR_RRC_CONNECTED: In Third Generation Partnership Project (3GPP) technologies like 5G NR or a 4G LTE, a mobility in a RRC_CONNECTED is network controlled. A NR supports a connected mode mobility (i.e. handover) from the NR to the LTE (e.g., Evolved Universal Terrestrial Radio Access Network (E-UTRA) or the like). The NR also supports the connected mode mobility to a 3G Universal Mobile Telecommunications System (UMTS) for voice services (i.e., Single Radio Voice Call Continuity (SRVCC) to a UMTS Frequency-Division Duplexing (FDD)). Similarly, the NR also supports mobility to the NR from the LTE. According to the 3GPP, the inter RAT mobility is characterized by the following:
a) A source RAT configures a target RAT measurement and reporting.
b) The source RAT decides on a handover preparation initiation and provides a necessary information to a target RAT in a format required by the target RAT:
c) Radio resources are prepared in the target RAT before a handover (HO) and the target RAT sends an RRC reconfiguration to the source RAT embedded in a Xn (Xn in the interface between an gNB and an eNB or between two eNBs) message.
d) The RRC reconfiguration message from the target RAT is delivered to the source RAT via a transparent container, and is passed to the UE by the source RAT. For the mobility from the NR (i.e. When the source RAT is the NR), the gNB sends a MobilityFromNRCommand to the UE. The definition of MobilityFromNRCommand message in the NR TS 38.331 is given below for reference:

| | | |
|---|---|---|
| MobilityFromNRCommand ::= | | SEQUENCE { |
| rrc-TransactionIdentifier | | RRC-TransactionIdentifier, |
| criticalExtensions | | CHOICE { |
| | mobilityFromNRCommand | MobilityFromNRCommand-IEs, |
| | criticalExtensionsFuture | SEQUENCE { } |

```
        }
      }
```

| | | |
|---|---|---|
| MobilityFromNRCommand-IEs ::= | | SEQUENCE { |
| | targetRAT-Type | ENUMERATED { eutra, utra-fdd-v1610, spare2, |

spare1, ...},

| targetRAT-MessageContainer | OCTET STRING, | |
|---|---|---|
| nas-SecurityParamFromNR | | OCTET STRING |

OPTIONAL, -- Cond HO-ToEPCUTRAN

| | |
|---|---|
| lateNonCriticalExtension | OCTET STRING |

OPTIONAL,

| | |
|---|---|
| nonCriticalExtension | MobilityFromNRCommand-v1610-IEs |

```
        OPTIONAL
        }
```

| MobilityFromNRCommand-v1610-IEs ::= | | SEQUENCE { | |
|---|---|---|---|
| | voiceFallbackIndication-r16 | | ENUMERATED {true} |

OPTIONAL, -- Need N

| | | | |
|---|---|---|---|
| e) | nonCriticalExtension | SEQUENCE { } | OPTIONAL |

```
        The UE RRC decodes RRC Reconfiguration message, synchronises with the target
        RAT and performs a random access (RA). Once the random access is successful, the
        UE sends the RRC Reconfiguration Complete on the target RAT.
  If the Inter-RAT handover from the NR to the LTE is due to the voice fallback (i.e.,
UE falls back to the LTE for voice services, possibly because voice over NR is not
supported), the network apparatus indicates a flag-voiceFallbackIndication, which is
set as true as below. The 3GPP definition for voiceFallbackIndication for the handover
is as below:
```

voiceFallbackIndication
Indicates the handover is triggered by EPS fallback for IMS voice as specified
in TS 23.502.

When the voice fallback is needed but the inter-RAT handover is not possible, the network apparatus redirects the UE to an Evolved Packet System (EPS) (LTE) using a RRC message, a RRC Release for redirection includes voiceFallbackIndication set as true. The network apparatus (e.g., gNodeB) sends the RRC Release when the handover is not possible, for e.g. due to the non-availability of interface with a LTE node (e.g., eNB).

Self-Optimisation in the NR: A 5G NR radio access network (RAT) also known as NG-RAN (Next Generation Radio Network) comprises of a number of NR base stations knows as gNBs. The gNBs can be connected to each other through an Xn interface, and is connected to various core network elements like AMF (Access and Mobility Management Function), UPF (User Plane Function) etc. Further, the gNBs can be divided into two physical entities named as a CU (Centralized Unit) and a DU (Distributed Unit). The CU provides support for higher layers of a protocol stack such as SDAP (Session Data Application Protocol), PDCP (Packet Data Convergence Protocol) and RRC (Radio Resource Control) while the DU provides support for the lower layers of the protocol stack such as RLC (Radio Link Control), MAC (Medium Access Control) and Physical layer. Each gNB can have multiple cells serving many UEs (User Equipment). There are a large number of techniques and configuration parameters used in the NG-RAN. Especially, it is a very difficult task to identify the most optimal radio parameters and operators used to resort to manual techniques like drive tests to identify the optimal parameters. However, such manual parameter tuning is a costly operation since the manual parameter depends on a lot of factors like the number of users, number of neighbour cells, maximum throughput in the cell, average throughput in the cell etc.

Further, whenever a neighbor gNB is installed or a new service is introduced, many of these manual operations need to be repeated. To resolve the above mentioned problem, the 3GPP has introduced Self-Organizing Networks (SON) techniques in the wireless technologies like NR. The SON is first introduced in the 3GPP release 9, in the LTE. SON solutions can be divided into three categories such as Self-Configuration, Self-Optimization and Self-Healing. A SON architecture can be a centralized, distributed or a hybrid solution. A Mobility Robustness Optimization (MRO) is a SON technique which is used to optimize various parameters related to mobility.

According to 3GPP specifications like technical specification (TS) 38.300 V17.0.0, Mobility Robustness Optimization aims at detecting and enabling correction of following problems:
a) Connection failure due to intra-system or inter-system mobility;
b) Inter-system Unnecessary HO (too early inter-system HO from the NR to the EUTRAN with no radio link failure);
c) Inter-system HO ping-pong.

The MRO provides means to distinguish the above problems from NR coverage related problems and other problems, not related to mobility. For analysis of connection failures, the UE makes the Radio Link Failure (RLF) Report available to the network apparatus. The UE stores a latest RLF Report, including both LTE and NR RLF report until the RLF report is fetched by the network apparatus or for specified time (e.g., 48 hours) after the connection failure is detected. The UE may report several information for aiding the MRO. It is also important to minimise the amount of data reported by the UE for the MRO to avoid congestion on the air interface and the subsequent performance loss.

One of the functions of Mobility Robustness Optimization in the NR R17 is to detect connection failures that occurred due to too early or too late inter-system handovers. These problems are defined as follows:

a) Inter-system/Too Late Handover (HO): an RLF occurs after the UE has stayed in a cell belonging to an NG-RAN node for a long period of time, the UE attempts to reconnect to a cell belonging to an E-UTRAN node.

b) Inter-system/Too Early Handover: an RLF occurs shortly after a successful handover from a cell belonging to an E-UTRAN node to a target cell belonging to an NG-RAN node, the UE attempts to re-connect to the source cell or to another cell belonging to an E-UTRAN node.

One of the purposes of inter-system Mobility Robustness Optimization in the NR R17 is the detection of a non-optimal use of network resources. In particular, in case of inter-system operations and when NR is considered, the case known as Unnecessary HO to another system is identified. The problem is defined as follows:

a) The UE is handed over from the NR to the E-UTRAN even though quality of the NR coverage was sufficient for the service used by the UE. The handover is therefore considered as unnecessary HO to another system (i.e. EPS) (too early inter-system HO without connection failure).

In inter-system HO, if the serving cell threshold (NR cell) is set too high, and cell in another system (i.e. EPS) with good signal strength is available, the handover to another system is triggered unnecessarily, resulting in an inefficient use of the wireless network. With a lower threshold, the UE could have continued in the source system (i.e., 5GS).

One of the functions of mobility robustness optimization is to detect ping-pongs that occur in an inter-system environment. The problem is defined as follows:

a) The UE is handed over from a cell in the source system (e.g. 5GS) to a cell in a target system different from the source system (e.g. EPS), then within a predefined limited time the UE is handed over back to a cell in the source system, while the coverage of the source system was sufficient for the service used by the UE. The event occurs more than once.

It is desired to address the above mentioned disadvantages or other short comings or at least provide a useful alternative.

Accordingly the embodiment herein is to provide a method for self-optimization in a wireless network. The method includes receiving, by a UE, a first RRC message. Further, the method includes receiving, by the UE, a mobility command for an inter-RAT handover. Further, the method includes triggering, by the UE, the inter-RAT handover from a source RAT to a target RAT in the wireless network upon receiving the mobility command. Further, the method includes determining, by the UE, whether at least one of the first RRC message includes a threshold for a SHR for the inter-RAT handover', and the mobility command includes at least one of the threshold for the SHR for the inter-RAT handover, and a voice fallback indication'. In an embodiment, the method includes detecting whether the threshold configured for the SHR for the inter-RAT handover is satisfied when at least one of the first RRC message includes the threshold for the SHR and the mobility command includes the threshold for the SHR for the inter-RAT handover, and logging or skipping logging of the SHR for the inter-RAT handover when the threshold configured for the SHR for the inter-RAT handover is satisfied. In another embodiment, the method includes detecting a RLF during or after performing the inter-RAT handover when the mobility command includes the voice fallback indication, and logging an indicator indicating the mobility is for a voice fallback in a RLF report for the RLF during or after performing the inter-RAT handover.

The proposed method provides a SON for inter-RAT mobility. Further, the proposed method provides enhancements on the SON related reporting of Inter-RAT successful handover and both success and failure cases for voice fallback from NR through handover or redirection. Furthermore, for the failure cases, the proposed method provides enhancements for RLF reporting and connection establishment failure (CEF) reporting.

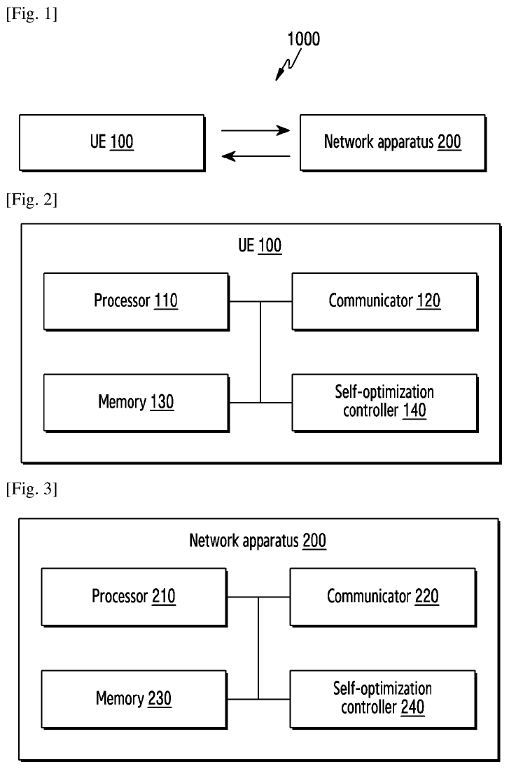

FIG. 1 illustrates a wireless network (1000) for self-optimization, according to the embodiments as disclosed herein. In an embodiment, the wireless network (1000) includes a UE (100) and a network apparatus (200). The wireless network (1000) can be, for example, but not limited to a fourth generation (4G) network, a fifth generation (5G) network, an Open Radio Access Network (ORAN) or the like.

The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a gNB, a eNB, a new radio (NR) trans-receiver or the like.

The UE (100) receives a first RRC message. The first RRC message can be, for example, but not limited to a RRC reconfiguration message and a RRC resume message. Further, the UE (100) receives a mobility command for an inter-RAT handover. Upon receiving the mobility command, the UE (100) triggers the inter-RAT handover from a source RAT to a target RAT in the wireless network (1000). Further, the UE (100) determines whether at least one of the first RRC message includes at least one threshold for a SHR for the inter-RAT handover', and the mobility command includes at least one of the at least one threshold for the SHR for the inter-RAT handover, and a voice fallback indication'.

Further, the UE (100) detects whether the threshold configured for the SHR for the inter-RAT handover is satisfied when at least one of the first RRC message includes the threshold for the SHR and the mobility command comprises the at least one threshold for the SHR for the inter-RAT handover, and logs or skips logging of the SHR for the inter-RAT handover when the threshold configured for the SHR for the inter-RAT handover is satisfied.

In an embodiment, the UE (100) determine whether the source RAT is a NR or an E-UTRA, or UTRA and the target RAT is the NR or the E-UTRA, or the UTRA. The UE (100) logs the SHR for the inter-RAT handover when the source RAT is the NR and the target RAT is the E-UTRA or when the source RAT is the E-UTRA and the target RAT is the NR. Alternatively, the UE (100) skips log of the SHR when the source-RAT is the NR and the target RAT is the UTRA or when the source RAT is the UTRA and the target RAT is the NR. In an embodiment, the SHR for the inter-RAT handover is logged by storing at least one of a PLMN identifier or a SNPN identifier, a cell identifier of a source cell and a target cell, measurement results of source NR cell and inter-RAT and intra-RAT neighbours, random access related information, location information, user plane interruption information, a C-RNTI in the source cell and a C-RNTI in the target cell, and a time taken for performing the inter-RAT handover. In another embodiment, logging the SHR for the inter-RAT handover is skipped when the mobility command is received while a NR timer T316 is running. In an embodiment, the Inter-RAT SHR is stored using the same UE variables used for storing Intra-RAT SHR, and all the embodiments, for inter-RAT SHR are applicable in this scenario.

Further, the UE (100) detects the RLF during or after performing the inter-RAT handover when the mobility command comprises the voice fallback indication, and logs an indicator indicating the mobility is for the voice fallback in a RLF report for the RLF during or after performing the inter-RAT handover.

In an embodiment, the UE (100) receives a UE capability request message from the network apparatus (200). Further, the UE (100) sends a UE capability response message to the network apparatus (200). The UE capability response message includes at least one of: a support of the UE (100) for storage and delivery of the SHR for the inter-RAT handover from at least one of the NR to the E-UTRA and the E-UTRA to the NR, and a support of the UE (100) for storing and reporting information about the voice fallback.

In an embodiment, the UE (100) sends at least one of an indication of availability of the SHR for the inter-RAT handover when at least one of the first RRC message comprises the threshold for the SHR and the mobility command comprises the at least one threshold for the SHR for the inter-RAT handover or an indication of availability of the RLF report when the mobility command comprises the voice fallback indication.

In an embodiment, the UE (100) releases the threshold for the SHR for the inter-RAT handover during at least one of an initiation of RRC connection Resume procedure, and an initiation of RRC Reestablishment procedure.

In an example, Inter-RAT Success handover reporting-Capability and Other config exchange between the UE (100) and a network apparatus (200) (e.g., gNB, eNB or the like)—The NR UE (100) which is capable of Inter-RAT Successful Handover Report (Inter-RAT SHR) sends the capability for storage and delivery of Inter-RAT SHR to the network apparatus (200) (gNB/eNB). In an embodiment, this may be a separate optional capability bit than the capability for Intra-NR Successful Handover Report (SHR), which as per-UE capability without FDD-TDD differentiation while in another embodiment, the UE (100) uses same capability bit in the current system for indicating Intra-NR SHR to indicate that it supports both Intra-NR SHR and Inter-RAT SHR.

An example specification extract in TS 38.306 with the embodiment is given below:

| | | | FDD- | FR1- |
|---|---|---|---|---|
| | | | TDD | FR2 |
| Definitions for parameters | Per | M | DIFF | DIFF |
| success-HO-Report-Inter-RAT-r18 | UE | No | No | No |
| Indicates whether the UE supports the | | | | |
| storage and delivery of Successful | | | | |
| Handover Report for inter-RAT | | | | |
| handovers | | | | |

In an embodiment, the UE (100) reports a separate bit to indicate whether the UE (100) supports Inter-RAT SHR to the 3G UMTS (SHR for SRVCC Handover). An example specification extract from the TS 38.306 with the embodiment is given below:

| | | | FDD- | FR1- |
|---|---|---|---|---|
| | | | TDD | FR2 |
| Definitions for parameters | Per | M | DIFF | DIFF |
| success-SRVCC-UTRAFDD- | UE | No | No | No |
| Report-r18 | | | | |
| Indicates whether the UE supports | | | | |
| the storage and delivery of | | | | |
| Successful Handover Report for | | | | |
| SRVCC to UTRA FDD | | | | |

The UE capable of the Inter-RAT SHR receives a configuration from the network apparatus (200) in the RRC message (for e.g. other config in NR RRC Reconfiguration) to store and deliver the Inter-RAT SHR. An example specification extract from the TS 38.331 with the embodiment is given below:

| 1> | if the received otherConfig includes the inter-RATSuccessHO-Config: |
|---|---|
| 2> | consider itself to be configured to provide the inter-RAT successful |
| handover information in accordance with 5.x.x.x; | |
| 1> | else: |
| 2> | consider itself not to be configured to provide the inter-RAT successful |

handover information.

Similarly, the NR UE capable of SRVCC to the UTRA FDD receives a configuration, SRVCC-UTRAReportConfig, from the network apparatus (200) to store and deliver Successful Handover Report for SRVCC to UTRA FDD. The configuration and SRVCC-UTRAReportConfig is received in otherconfig in RRC Reconfiguration.

Upon initiation for RRC Reestablishment procedure, the UE (100) releases interRATSuccessHO-Config and SRVCC-UTRAReportConfig, if configured.

As an alternative embodiment, existing structure “successHO-Config” can be extended to include an indication for inter-RAT HO reporting or the SRVCC to the UTRA FDD reporting. For e.g., a new set of fields for inter-RATSuccessHO-Config can be included for SRVCC to UTRA FDD reporting.

Upon initiation of RRC connection Resume, the UE (100) releases interRATSuccessHO-Config and SRVCC-UTRAReportConfig from the UE Inactive AS context, if stored.

As an alternative embodiment, existing structure “successHO-Config” can be extended to include an indication for inter-RAT HO reporting or SRVCC to UTRA FDD reporting. A new set of fields for inter-RATSuccessHO-Config can be included for SRVCC to UTRA FDD reporting.

Logging Aspects: the UE (100) is configured with thresholds for one or more of the (NR) timers—t304, t310, t312 for inter-RAT SuccessHO reporting (including both successful handover to E-UTRA and SRVCC to UTRA FDD). The UE (100) may be also configured with the timer values for T310, T312 and T304. For the Inter-RAT mobility from the NR to the LTE, T310 and T312 may be configured by the current source NR PCell or any of the earlier NR PCells where the UE (100) has been connected before performing the Inter-RAT mobility while for Intra-NR mobility T310 and T312 may be configured by the current source NR PCell alone. For the Inter-RAT mobility from the LTE to the NR, the T304 may be configured by the target NR PCell. If any of T304/T310/T312 (In an embodiment, the UE (100) may consider only the timers from the cells, as configured above), is running while inter-RAT HO happens (i.e. while mobility From NR command is received) and the corresponding threshold(s) exceeds the configured threshold percentage, the UE (100) stores Inter-RAT SHR and delivers the Inter-RAT SHR to the network apparatus (200) (e.g., gNB or the like) when requested (gNb requests for e.g. through UE information request). In an embodiment, the capability, configuration, logging and reporting may be restricted for Inter-RAT handover from the NR to the LTE or from the LTE to the NR. This will reduce the implementation complexity and the cost on the air interface.

If the timers T304/T310/T312 were running (as configured by the cells, as mentioned above) and the ratio between the value of the elapsed time of the timer T304/T310/T312 and the configured value of the timer T304/T310/T312 is greater than thresholdPercentageT304/thresholdPercentageT310/thresholdPercentageT312 included in the Inter-RATSuccessHO-Config-r18 received before executing the Mobility From NR command, the UE (100) stores Inter-RAT SHR and delivers the Inter-RAT SHR to the gNB when requested.

In an embodiment, the network apparatus (200) (e.g., gNB or the like) configures the UE (100) with the threshold duration (timer for e.g. T3XX)—If the Inter-RAT handover is not completed within the threshold duration, the UE (100) stores the inter-RAT SHR. If the Inter-RAT handover is completed within the threshold duration, the UE (100) does not store inter-RAT SHR.

In an embodiment, the network apparatus (200) (e.g., gNB or the like) configures the UE (100) (i.e. UE (100) receives configuration in the RRC message like RRC Reconfiguration) with the threshold duration (timer) for the time stayed in the target cell after Inter-RAT handover to LTE or UTRA FDD. If the UE (100) stayed in the Inter-RAT target cell for less than the duration or if there was a RLF in the Inter-RAT target cell within the duration, UE (100) logs and reports the Inter-RAT successful handover report. In an embodiment, the UE (100) logs the inter-RAT successful handover report in a temporary report and discards the same on expiry of the timer. In an embodiment, the timer is applicable only if there was a RLF in the Inter-RAT target cell within the duration.

An example specification extract from TS 38.331 with the some of the above embodiments is given below:

| | |
|---|---|
| Inter-RATSuccessHO-Config-r18 ::= | SEQUENCE { |
| thresholdPercentageT304-r17 | ENUMERATED {p40, p60, p80, spare5, spare4, |
| spare3, spare2, spare1} | OPTIONAL, -- Need M |
| thresholdPercentageT310-r17 | ENUMERATED {p40, p60, p80, spare5, spare4, |
| spare3, spare2, spare1} | OPTIONAL, -- Need M |
| thresholdPercentageT312-r17 | ENUMERATED {p20, p40, p60, p80, spare4, spare3, |
| spare2, spare 1} | OPTIONAL, -- Need M |
| thresholdDurationT3xx-r18 | ENUMERATED {s1, s2, s4, s8, spare4, spare3, spare2, |
| spare1} OPTIONAL -Need M | |
| thresholdDurationTimeStayedInTargetCell-r18 | ENUMERATED {s1, s2, s4, s8, spare4, |
| spare3, spare2, spare1} | OPTIONAL -Need M |
| ... | |
| } | |

In an embodiment, if the UE (100) supports SRVCC from 5G NR to UMTS, the UE (100) is configured by the network apparatus (200) (e.g., gNB or the like) to store and deliver SHR for SRVCC (i.e. inter RAT handover) from 5G NR to UMTS.

An example specification extract from TS 38.331 with the embodiment is given below:

Inter-RATSuccessHO-Config-r18 ::= SEQUENCE {
LogSRVCCToUTRA-FDDENUMERATED {TRUE} OPTIONAL, --Need M
...
}

Alternatively, the UE (100) is configured with a list of target RATs. The UE (100) logs and delivers the SHR for the inter RAT handovers from the NR to the list of targetRATs. The targetRAT could be LTE (E-UTRA) or UMTS (3G). If the targetRAT is the E-UTRA, the UE (100) stores the SHR for the handover from the NR to the LTE, while if the targetRAT is the UTRA (or UMTS or UTRA-FDD), the UE (100) stores the SHR for handovers from the NR to the UMTS and reports then to the network apparatus (200) (e.g., gNB or the like) when requested.

An example specification extract from TS 38.331 with the embodiment is given below:

Inter-RATSuccessHO-Config-r18 ::= SEQUENCE {
targetRATList SEQUENCE (SIZE (0..maxtargerRAT) OF targetRAT-Type
OPTIONAL, --Need M
...
}

targetRAT-Type ENUMERATED {eutra, utra-fdd-v1610, spare2, spare1, . . . },

If the threshold criteria in the Inter-RATSuccessHO-Config given above is fulfilled, the UE (100) stores Inter-RAT SHR including the below information:
1. PLMN identifier or SNPN identifier,
2. Cell identifier (CGI or PCI) of source cell and target cell. Target cell can be E-UTRA or UTRA cell,
3. Measurement results of source NR cell and inter-RAT as well as intra-RAT neighbours of the measObjectNR or measObjectEUTRA applied in the source PCell,
4. Random access related information (e.g. RA-Report),
5. Location information and other sensor information if available,
6. User plane interruption information,
7. C-RNTI in source and target cells,
8. Time taken for performing handover, i.e. time duration from the reception of mobility from NR command till sending RRC Connection Reconfiguration complete (alternately time till completing RACH successfully) is sent in the target RAT, and
9. Inter-RAT SHR cause. Cause value can be based on which threshold was exceeded resulting in the logging of inter-RAT SHR. The cause value can be thresholdPercentageT304-exceeded, thresholdPercentageT310-exceeded, thresholdPercentageT312-exceeded, thresholdDurationT3xx-exceeded and thresholdTimeStayedInTarget-exceeded.

An example specification extract from TS 38.331 for Inter-RAT SHR with the embodiment is given below:

| Inter-RATSuccessHO-Report-r18 ::= | SEQUENCE { | |
|---|---|---|
| sourceCellInfo-r17 | SEQUENCE { | |
| sourcePCellId-r17 | CGI-Info-Logging-r16, | |
| sourceCellMeas-r17 | MeasResultSuccessHONR-r17 | OPTIONAL, |
| rlf-InSourceDAPS-r17ENUMERATED {true} | | OPTIONAL |

},

| | |
|---|---|
| targetCellInfo-r17 | SEQUENCE { |

choice :: {
targetCell-E-UTRA CellGlobalIdEUTRA
targetCell-E-UTRACellGlobalIdUTRA

| | |
|---|---|
| } targetCellMeas-r17 | MeasResultInter-RATSuccessHONR-r17 |

OPTIONAL
},

| measResultNeighCells-r17 | SEQUENCE { | |
|---|---|---|
| measResultListNR-r17 | MeasResultList2NR-r16 | OPTIONAL, |
| measResultListEUTRA-r17 | | MeasResultList2EUTRA-r16 |

OPTIONAL
}

| | | |
|---|---|---|
| locationInfo-r17 | LocationInfo-r16 | OPTIONAL, |
| timeSinceCHO-Reconfig-r17 | | OPTIONAL, |
| shr-Cause-r17 | | OPTIONAL, |

ra-InformationCommon-r17RA-InformationCommon-r16OPTIONAL,
upInterruptionTimeAtHO-r17UPInterruptionTimeAtHO-r17OPTIONAL,
c-RNTI-r17

| | |
|---|---|
| timetakenforHO-r18 | ENUMERATED {s1, s2, s4, s8, spare4, spare3, spare2, spare1} |

OPTIONAL, -- Need M,

| Inter-RATSHR-cause | ENUMERATED{thresholdPercentageT304-exceeded, | |
|---|---|---|
| thresholdPercentageT310-exceeded, | | thresholdPercentageT312- |

exceeded,thresholdDurationT3xx-exceeded,thresholdTimeStayedInTarget-exceeded }
...
}

5.7.10.6 Actions for the successful handover report determination

The UE (100) shall:

| | |
|---|---|
| 3> | if the ratio between the value of the elapsed time of the timer T304 and the |
| | configured value of the timer T304, included in the last applied |
| | RRCReconfiguration message including the reconfigurationWithSync, is |
| | greater than thresholdPercentageT304 included in the successHO-Configor |
| | inter-RATSuccessHO-Config received before executing the last |
| | reconfiguration with sync; or |
| 3> | if the ratio between the value of the elapsed time of the timer T310 and the |
| | configured value of the timer T310, configured while the UE (100) was |
| | connected to the source PCell before executing the last reconfiguration with |
| | sync, is greater than thresholdPercentageT310 included in the successHO- |
| | Configorinter-RATSuccessHO-Config configured by the source PCell before |
| | executing the last reconfiguration with sync; or |
| 3> | if the T312 associated to the measurement identity of the target cell was running |
| | at the time of initiating the execution of the reconfiguration with sync |
| | procedure and if the ratio between the value of the elapsed time of the timer |
| | T312 and the configured value of the timer T312, configured while the UE |
| | (100) was connected to the source PCell before executing the last |
| | reconfiguration with sync, is greater than thresholdPercentageT312 included |
| | in the successHO-Configor inter-RATSuccessHO-Config configured by the |
| | source PCell before executing the last reconfiguration with sync; or |
| 3> | if sourceDAPS-FailureReporting included in the successHO-Config before |
| | executing the last reconfiguration with sync is set to true and if the last |
| | executed handover was a DAPS handover and if an RLF occurred at the |
| | source PCell during the DAPS handover while T304 was running; or |
| 3> | if the time interval between the reception of mobilityFromNR in the source cell |
| | and the completion of random access in the target cell is greater than T3XX |
| | or if the time UE (100) stayed in the target cell after successful inter-RAT |
| | handover is less than the thresholdTimeStayedInTarget; |

2>store the successful handover information in VarSuccessHO-Report or
varInter-RATsuccessHO-report and determine the content in VarSuccessHO-Report
or varInter-RATsuccessHO-report as follows:

| | |
|---|---|
| 3> | clear the information included in VarSuccessHO-Report or varInter- |

RATsuccessHO-report , if any;

| | |
|---|---|
| 3> | set the plmn-IdentityListto include the list of EPLMNs stored by the UE |

(100) (i.e., includes the RPLMN);

| | |
|---|---|
| 3> | set the c-RNTI to the C-RNTI assigned by the target PCell of the handover; |

3>If the handover type is Inter-RAThandover

| | |
|---|---|
| 3> | for the source Pcellin which the last RRCReconfiguration message |

including reconfigurationWithSync was applied:

| | |
|---|---|
| 4> | set the sourceCellID in sourceCellInfo to the global cell identity and |

tracking area code of the source PCell;

| | |
|---|---|
| 4> | set the sourceCellMeas in sourceCellInfo to include the cell level RSRP, |

RSRQ and the available SINR, of the source PCell based on the available SSB and
CSI-RS measurements collected up to the moment the UE (100) sends
RRCReconfigurationComplete message;

| | |
|---|---|
| 4> | set the rsIndexResults in sourceCellMeas to include all the available SSB |

and CSI-RS measurement quantities of the source PCell collected up to the moment
the UE (100) sends RRCReconfigurationComplete message;

| | |
|---|---|
| 4> | if the last executed handover was a DAPS handover and if an RLF occurred |

at the source PCell during the DAPS handover while T304 was running:

| | |
|---|---|
| 5> | set the rlf-InSourceDAPS in sourceCellInfo to true; |
| 3> | for the target PCell indicated in the last appliedRRCReconfiguration |

message including reconfigurationWithSync:

| | |
|---|---|
| 4> | set the targetCellID in targetCellInfo to the global cell identity and tracking |

area code of the target PCell;

| | |
|---|---|
| 4> | set the targetCellMeas in targetCellInfoto include the cell level RSRP, |

RSRQ and the available SINR, of the target Pcellbased on the available SSB and
CSI-RS measurements collected up to the moment the UE (100) sends
RRCReconfigurationComplete message;

| | |
|---|---|
| 4> | set the rsIndexResults in targetCellMeas to include all the available SSB and |

CSI-RS measurement quantities of the target PCell collected up to the moment the
UE (100) sends RRCReconfigurationComplete message;

| | |
|---|---|
| 4> | if the last appliedRRCReconfiguration message including |

reconfigurationWithSync was included in the stored condRRCReconfig:

| | |
|---|---|
| 5> | set the timeSinceCHO-Reconfig to the time elapsed between the initiation |

of the execution of conditional reconfiguration for the target PCell and the reception
of the last conditionalReconfiguration including the condRRCReconfig of the target
PCell in the source PCell;

| | |
|---|---|
| 3> | if the ratio between the value of the elapsed time of the timer T304 and the |

configured value of the T304 timer, included in the last applied
RRCReconfiguration message including the reconfigurationWithSync, is greater
than thresholdPercentageT304 included in the successHO-Configor inter-
RATSuccessHO-Config received before executing the last reconfiguration with
sync:

| | |
|---|---|
| 4> | set t304-cause in shr-Cause or Inter-RATSHR-cause to true; |
| 4> | set thera-InformationCommon as specified in clause 5.7.10.5; |
| 3> | if the ratio between the value of the elapsed time of the timer T310 and the |

configured value of the T310 timer, configured while the UE (100) was connected
to the source PCell before executing the last reconfiguration with sync, is greater
than thresholdPercentageT310 included in the successHO-Configor inter-
RATSuccessHO-Config configured by the source PCell before executing the last
reconfiguration with sync:

| | |
|---|---|
| 4> | set t310-cause inshr-Causeor Inter-RATSHR-cause to true; |
| 3> | if the ratio between the value of the elapsed time of the timer T312 and the |

configured value of the T312 timer, configured while the UE (100) was connected
to the source PCell before executing the last reconfiguration with sync, is greater
than thresholdPercentageT312 included in the successHO-Configor inter-
RATSuccessHO-Config configured by the source PCell before executing the last
reconfiguration with sync:

| | |
|---|---|
| 4> | set t312-cause inshr-Cause or Inter-RATSHR-cause to true; |
| 3> | if the time interval between the reception of mobilityFromNR in the source |

cell and the completion of random access in the target cell is greater than T3XX:

| | |
|---|---|
| 4> | set T3XX-Failureinshr-Causeor Inter-RATSHR-cause to true; |
| 3> | if sourceDAPS-FailureReporting included in the successHO-Config |

configured by the source PCell before executing the last reconfiguration with sync
is set to true, and if the last executed handover was a DAPS handover and if an RLF
occurred at the source PCell during the DAPS handover while T304 was running:

| | |
|---|---|
| 4> | set sourceDAPS-Failure inshr-Cause to true; |
| 3> | for each of the measObjectNR, configured by the source PCell, in which the |

last RRCReconfiguration message including reconfigurationWithSync or any of the
earlier Pcells (cells where the UE was in RRC_CONNECTED before moving to the
source PCell after moving from RRC_IDLE or RRC_INACTIVE last time) was
applied:

| | |
|---|---|
| 4> | if measurements are available for the measObjectNR: |
| 5> | if the SS/PBCH block-based measurement quantities are available: |
| 6> | set the measResultListNR in measResultNeighCells to include all the |

available measurement quantities of the best measured cells, other than the source
PCell or target PCell, ordered such that the cell with highest SS/PBCH block RSRP
is listed first if SS/PBCH block RSRP measurement results are available, otherwise
the cell with highest SS/PBCH block RSRQ is listed first if SS/PBCH block RSRQ
measurement results are available, otherwise the cell with highest SS/PBCH block
SINR is listed first, based on the available SS/PBCH block based measurements
collected up to the moment the UE (100) sends the RRCReconfigurationComplete
message;

| | |
|---|---|
| 6> | for each neighbour cell included, include the optional fields that are |

available;

| | |
|---|---|
| 5> | if the CSI-RS measurement quantities are available: |
| 6> | set the measResultListNR in measResultNeighCells to include all the |

available measurement quantities of the best measured cells, other than the source
PCell and target PCell, ordered such that the cell with highest CSI-RS RSRP is
listed first if CSI-RS RSRP measurement results are available, otherwise the cell
with highest CSI-RS RSRQ is listed first if CSI-RS RSRQ measurement results are
available, otherwise the cell with highest CSI-RS SINR is listed first, based on the
available CSI-RS based measurements collected up to the moment the UE (100)
sends the RRCReconfigurationComplete message;

| | |
|---|---|
| 6> | for each neighbour cell included, include the optional fields that are |

available;

| | |
|---|---|
| 3> | for each of the measObjectEUTRA, configured by the source PCell in which |

the last RRCReconfiguration message including reconfigurationWithSync or any
of the earlier Pcells (cells where the UE was in the RRC_CONNECTED before
moving to the source PCell after moving from RRC_IDLE or RRC_INACTIVE
last time) was applied:

| | |
|---|---|
| 4> | if measurements are available for the measObjectEUTRA: |
| 5> | set the measResultListEUTRA in measResultNeighCells to include the best |

measured cells ordered such that the cell with highest RSRP is listed first if RSRP
measurement results are available, otherwise the cell with highest RSRQ is listed
first, based on measurements collected up to the moment the UE (100) sends
theRRCReconfigurationComplete message;

| | |
|---|---|
| 5> | for each neighbour cell included, include the optional fields that are |

available;

| | |
|---|---|
| 3> | if available, set the locationInfo as in 5.3.3.7; |

3> set iRATHODelay to the time interval between the reception of
mobilityFromNR in the source cell and the completion of random access in the
target cell

In an embodiment, the SRVCC UTRA report is logged and delivered separately from Inter-RAT successful handover report, but can contain the same content as provided in the below embodiments.

In another embodiment, the UE (100) is configured to report SHR for the mobility from the LTE (E-UTRA) to the NR. The UE (100) reports the capability to store (and report when requested) the SHR for the handover from the E-UTRA to the NR and the network apparatus (e.g., eNB or the like) (200) configures the UE (100) to log and report the SHR. The network apparatus (e.g., eNB or the like) (200) configures the threshold percentage for T304/T310/T312 and requests the UE (100) to log and report SHR when the timers have crossed the corresponding percentage. If the thresholds are crossed, the UE (100) stores the PLMN ID or SNPN ID, the source and target cell identifier, the RA information, the location information, the C-RNTI,UP interruption information and the time take for the handover to complete, i.e. the duration between reception of mobility from E-UTRA till random access is completed in NR (or RRC reconfiguration complete is send in NR).

The UE (100) which is capable of storing and reporting voice fallback related information for SON/MDT indicates the capability for storage and delivery of voice fallback indication related information to the network apparatus (200) (e.g., gNB or the like). In an embodiment, the UE (100) indicates the capability for storage and delivery of voice fallback indication related information separately for voice fallback through redirection and voice fallback through handover. In an embodiment, the same information used for indicating the capability for successful handover reporting is used for indicating the capability for voice fallback for handover also. In an embodiment, the same information used for indicating the capability for successful handover reporting is used for indicating the capability for the voice fallback for redirection.

An example specification extract from the TS 38.306 with some of the embodiments is given below:

| | | | FDD- | FR1- |
|---|---|---|---|---|
| | | | TDD | FR2 |
| Definitions for parameters | Per | M | DIFF | DIFF |
| voice Fallback-HO-Report- - r18 | UE | No | No | No |
| Indicates whether the UE (100) supports the | | | | |
| storage and delivery of reports for voice fall | | | | |
| back through handover | | | | |
| voiceFallback-Redirection-Report- - r18 | UE | No | No | No |
| Indicates whether the UE (100) supports the | | | | |
| storage and delivery of reports for voice fall | | | | |
| back through redirection | | | | |

In an embodiment, the network apparatus (200) (e.g., gNB or the like) configures the UE (100) to log the voice fallback information through the RRC Reconfiguration. In an embodiment, the network apparatus (200) configures the UE (100) to log the voice fallback information for voice fallback through redirection (voiceFallbackRedirectionConfig) and voice fallback information for voice fallback through the handover (voiceFallbackHOConfig) separately in the RRC Reconfiguration message. In an embodiment, the network apparatus (200) configures the UE (100) to log the voice fallback information based on the same configuration for inter-RAT success handover configuration.

In an embodiment, the UE (100) logs the voice fallback related information in the SHR or the connection establishment failure (CEF) report or the RLF report.

Upon initiation for RRC Reestablishment procedure, the UE (100) releases voiceFallbackRedirectionConfig and voiceFallbackHOConfig, if configured. Upon initiation of RRC connection Resume, the UE (100) releases voiceFallbackRedirectionConfig and voiceFallbackHOConfig from the UE inactive AS context, if stored.

An example specification extract from TS 38.331 with some of the embodiments is given below:

| | |
|---|---|
| 1> | if the received otherConfig includes the voiceFallbackHOConfig: |
| 2> | consider itself to be configured to provide the voice fallback information for |

voice fallback through handover;

| | |
|---|---|
| 1> | else: |
| 2> | consider itself not to be configured to provide the voice fallback information |

for voice fallback through handover.

| | |
|---|---|
| 1> | if the received otherConfig includes the voiceFallbackRedirectionConfig: |
| 2> | consider itself to be configured to provide the voice fallback information for |

voice fallback through redirection;

| | |
|---|---|
| 1> | else: |
| 2> | consider itself not to be configured to provide the voice fallback information |

for voice fallback through redirection.

If the UE (100) has received mobilityFromNRCommand including field voice fallback indication and the UE (100) performed successful handover to LTE, the UE (100) logs the following in Inter-RAT successful handover reports along with other information for Inter-RAT SHR as in previous embodiments. In an embodiment, the UE (100) logs successful voice fallback related information in a report separate from successful handover report (SHR).

a. An indicator which indicates that the successful Inter-RAT handover is for voice fallback. In an embodiment, the indicator is provided using a shr-cause which informs the network apparatus (200) that the SHR was for voice fallback. A separate SHR-cause informs the network apparatus (200) (e.g., gNB or the like) that the SHR was a redirection for voice fallback.

b. Call setup Delay—the UE (100) logs the time taken for call setup with voice call fallback. The voice call fallback could be the time duration between receiving mobilityFromNRCommand with voice fallback indication and the time for completing the handover successfully (sending RRC Reconfiguration complete). Alternately, call setup time is calculated as the time duration when the UE (100) initiates the call in NR and the call is successfully transferred to EPS or time the voice bearer is established in EPS, or for MT calls, the time the UE (100) received paging to the time the call is successfully transferred to EPS or time the voice bearer is established in EPS.

c. Interruption time for voice bearer if the voice call was already going on in NR

An example specification according to TS 38.331 with the embodiment is given below:

| Inter-RATSuccessHO-Report-r18 ::= | | SEQUENCE { | |
|---|---|---|---|
| sourceCellInfo-r17 | | SEQUENCE { | |
| | sourcePCellId-r17 | CGI-Info-Logging-r16, | |
| | sourceCellMeas-r17 | MeasResultSuccessHONR-r17 | OPTIONAL, |

| | |
|---|---|
| rlf-InSourceDAPS-r17ENUMERATED {true} | OPTIONAL |

},

| | |
|---|---|
| targetCellInfo-r17 | SEQUENCE { |

choice :: {

targetCell-E-UTRA CellGlobalIdEUTRA
targetCell-E-UTRACellGlobalIdUTRA

| | | |
|---|---|---|
| } | targetCellMeas-r17 | MeasResultInter-RATSuccessHONR-r17 |

OPTIONAL

},

| | | |
|---|---|---|
| Inter-RATSHR-cause | ENUMERATED{ | thresholdPercentageT304-exceeded, |

| | |
|---|---|
| thresholdPercentageT310-exceeded, | thresholdPercentageT312- |

exceeded,thresholdDurationT3xx-exceeded }

| measResultNeighCells-r17 | | SEQUENCE { | |
|---|---|---|---|
| | measResultListNR-r17 | MeasResultList2NR-r16 | OPTIONAL, |

| | |
|---|---|
| measResultListEUTRA-r17 | MeasResultList2EUTRA-r16 |

OPTIONAL

}

| | | |
|---|---|---|
| locationInfo-r17 | LocationInfo-r16 | OPTIONAL, |

| | |
|---|---|
| timeSinceCHO-Reconfig-r17 | TimeSinceCHO-Reconfig-r17 |

OPTIONAL,

| shr-Cause-r17 | SHR-Cause-r17 | OPTIONAL, |
|---|---|---|
| ra-InformationCommon-r17RA-InformationCommon-r16OPTIONAL, | | |
| upInterruptionTimeAtHO-r17UPInterruptionTimeAtHO-r17OPTIONAL, | | |
| c-RNTI-r17 | | |
| timetakenforHO-r18 | ENUMERATED {s1, s2, s4, s8, spare4, spare3, spare2, spare1} | |
| OPTIONAL, -- Need M | | |
| voice-fallback-indication | ENUMERATED {true} | OPTIONAL |

| | |
|---|---|
| callSetupDelay | ENUMERATED {s1, s2, s4, s8, spare4, spare3, spare2, spare1 } |

OPTIONAL, -- Need M
voiceInterruptionTimeAtHO-r18UPInterruptionTimeAtHO-r17OPTIONAL,
...
}

In an embodiment, the above information is logged by NR RRC in NR SHR. In an embodiment above information is logged by LTE RRC in LTE SHR. In an embodiment, above information is logged in a new report for logging voice fallback information by handover

If the UE (100) is redirected to the E-UTRA frequency for voice fallback i.e. RRC Release including E-UTRA carrier (i.e. RedirectedCarrierInfo includes E-UTRA information with an eutra Frequency) and voiceFallBack information is true, the UE (100) logs the following in inter-RAT redirection information for voice fallback.

i. An indicator which indicates that the successful Inter-RAT redirection for voice fallback has been performed. In an embodiment, the information is provided explicitly, while in an alternate embodiment, the information is implicitly provided.

ii. A call setup delay—the UE (100) logs the time taken for call setup with voice call fallback. The call setup delay could be the time between receiving mobilityFromNRCommand with voice fallback indication and the time for completing the handover successfully (for e.g. sending RRC message RRC Reconfiguration complete). Alternately, call setup time is calculated as the time when the UE (100) initiates the call in NR and the call is successfully setup in EPS (time the voice bearer is established in EPS), or for MT calls, the time the UE (100) received paging to the time the call is successfully setup in EPS or time the voice bearer is established in EPS. In yet another alternative embodiment, for a mobile originated call, the UE (100) logs the call setup delay as the time from the user initiating the call till the user receives notification about the called party is alerted (alternatively till the call is successfully connected). In an alternative embodiment, for a mobile terminated call, the UE (100) logs the call setup delay as the time from user receiving the paging till the call is successfully connected.

iii. Interruption time for the voice bearer if the voice call was already going on in the NR.

iv. The time delay (Tconnection_release_redirect_E-UTRA), the time between the end of the last slot containing the RRC command, “[RRCConnectionRelease]” on the PDSCH and the time the UE (100) starts to send random access to the target E-UTRA cell. The UE (100) also logs Tconnection_release_redirect_E-UTRA+the time for performing random access successfully (RACH completed as successfully received msg4). The UE (100) also logs Tconnection_release_redirect_E-UTRA+the time for performing random access successfully (RACH completed as successfully received msg4)+the time for receiving UL grant for sending LTE RRC message RRC Connection setup complete.

v. PLMN identifier of the source cell, if applicable.

vi. PLMN identifier of the target cell, if applicable.

vii. NPN identifier of source cell, if applicable.

viii. NPN identifier of target cell, if applicable.

ix. Source NR cell and the cell selected after redirection in NR (or the list of cells selected till the successful redirection)

x. Indicates if there was a connection establishment failure, if the cell selected initially is not the cell where the UE (100) has successfully setup a voice call.

xi. Indicates if the connection establishment was aborted due to access not allowed or receiving Reject from RRC before the successful redirection.

xii. E-UTRA ARFCN where the UE (100) was redirected.

xiii. In an embodiment, the UE (100) stores the redirection report if the time for completing the redirection successfully (any delay as in point d. is used) is above a threshold.

The UE (100) also logs the additional information like measurements etc. as given in below specification extract in Inter-RAT redirection information for voice fallback.

An example specification according to TS 38.331 with some of the embodiments is given below:

| VoiceFallbackRedirection-Report-r18 ::= | | SEQUENCE { | |
|---|---|---|---|
| sourceCellInfo-r17 | | SEQUENCE { | |
| | sourcePCellId-r17 | CGI-Info-Logging-r16, | |
| | sourceCellMeas-r17 | MeasResultSuccessHONR-r17 | OPTIONAL, |

| | }, | |
|---|---|---|
| selectedCellInfo-r17 | | SEQUENCE { |

choice :: {

selectedCell-E-UTRA CellGlobalIdEUTRA
selectedCell-E-UTRACellGlobalIdUTRA

| | | |
|---|---|---|
| } | campedCellMeas-r17 | MeasResultInter-RATSuccessHONR-r17 |

OPTIONAL

| | }, | | |
|---|---|---|---|
| measResultNeighCells-r17 | | SEQUENCE { | |
| | measResultListNR-r17 | MeasResultList2NR-r16 | OPTIONAL, |

| | |
|---|---|
| measResultListEUTRA-r17 | MeasResultList2EUTRA-r16 |

OPTIONAL

| | } | | |
|---|---|---|---|
| locationInfo-r17 | | LocationInfo-r16 | OPTIONAL, |
| voice-fallback-indication | | ENUMERATED {true} | OPTIONAL |

| | |
|---|---|
| callSetupDelay | ENUMERATED {s1, s2, s4, s8, spare4, spare3, spare2, spare1} |

OPTIONAL, -- Need M
voiceInterruptionTimeAtHO-r18UPInterruptionTimeAtHO-r17OPTIONAL,
...
}

In an embodiment, if there was a radio link failure after Inter-RAT handover for voice fallback, the UE (100) logs an indicator to indicate that the failure was for an inter-RAT handover for voice fallback in the radio link failure information. The network apparatus (200) (e.g., gNB or the like) retrieves the information through the UE information procedure. In an embodiment, the UE (100) logs if the UE (100) is able to select a suitable E-UTRA cell after the radio link failure. The UE (100) also logs the call setup delay as in the Inter-RAT SHR.

In an embodiment, if there was the radio link failure during Inter-RAT handover for the voice fallback, the UE (100) logs an indicator to indicate that the failure was for the inter-RAT handover for the voice fallback in the radio link failure information. The network apparatus (200) (e.g., gNB or the like) retrieves the information through the UE information procedure.

In an embodiment, if there was a connection establishment failure (CEF) while performing inter-RAT handover for voice fallback, the UE (100) logs an indicator that there was an inter-RAT handover for voice fallback in the connection failure information in the LTE CEF report. The UE (100) also logs the time elapsed till connection establishment failure from the time mobilityFromNRCommand is received. In an embodiment, if there was a connection establishment failure (CEF) while performing inter-RAT redirection for voice fall back, the UE (100) logs an indicator that there was an inter-RAT redirection for voice fallback in the connection establishment failure information in the E-UTRA CEF report. The UE (100) also logs the call setup delay as in the inter-RAT SHR for CEF due to Inter-RAT HO or Inter-RAT redirection.

In an embodiment, if the UE (100) is unable to select a suitable E-UTRA cell after inter-RAT redirection for the voice fall back, the UE (100) logs that it the UE (100) not able to select the E-UTRA cell for voice fallback in the inter-RAT redirection information.

In an embodiment, the call setup delay is logged in quality of experience (QoE) reports and reported to QoE servers by the UE (100).

In an embodiment, the UE (100) logs an indication that the E-UTRA cell is visited due to voice fallback from NR to E-UTRA in the mobility history information. In an embodiment, the UE (100) logs an indication that a NR cell is visited due to return from voice fallback from E-UTRA to the NR.

In an embodiment, in the mobility history information, the UE (100) logs the time duration UE (100) spent outside NR due to voice fallback to another RAT like EUTRA or UMTS. If the UE (100) has moved from NR multiple times for voice fallback to another RAT like E-UTRA or UMTS, the UE (100) logs the total duration UE spend outside NRs for all those times.

An example specification according to TS 38.331 with the embodiment is given below:

-- ASN1START
-- TAG-VISITEDCELLINFOLIST-START

| | |
|---|---|
| VisitedCellInfoList-r16 ::= | SEQUENCE (SIZE (1..maxCellHistory-r16)) OF |

VisitedCellInfo-r16

| | |
|---|---|
| VisitedCellInfo-r16 ::= | SEQUENCE { |
| visitedCellId-r16 | CHOICE { |
| nr-CellId-r16 | CHOICE { |
| cgi-Info | CGI-Info-Logging-r16, |
| pci-arfcn-r16 | SEQUENCE { |
| physCellId-r16 | PhysCellId, |
| carrierFreq-r16 | ARFCN-ValueNR |

```
      }
        returnFrom VoiceFallback ENUMERATED {TRUE} OPTIONAL,
    },
```

| | |
|---|---|
| eutra-CellId-r16 | CHOICE { |
| cellGlobalId-r16 | CGI-InfoEUTRA, |
| pci-arfcn-r16 | SEQUENCE { |
| physCellId-r16 | EUTRA-PhysCellId, |
| carrierFreq-r16 | ARFCN-ValueEUTRA |

}

| | |
|---|---|
| voiceFallback | ENUMERATED {TRUE} OPTIONAL, |

}

| | |
|---|---|
| } | OPTIONAL, |
| timeSpent-r16 | INTEGER (0..4095), |

```
    timeSpentForVoiceFallback-r18 INTEGER (0..4095) OPTIONAL,
  ...,
  [[
```

| | |
|---|---|
| visitedPSCellInfoList-r17 | OPTIONAL |

]]
}

In an embodiment, the UE (100) logs an indication that there is no PSCell during an interval due to voice fallback to E-UTRA. In an embodiment, in the visitedPSCellInfoList. The UE (100) logs the time duration when there was no PSCell due to the UE (100) not in NR due to voice fallback. If the UE (100) has moved from NR multiple times for voice fallback to another RAT like E-UTRA or UMTS, the UE (100) logs the total duration the UE spent without PSCell from all those times.

In an embodiment, the UE (100) logs the total time duration it spend outside NR by calculating the total time duration the spend outside the NR, excluding the time it spend outside the NR due to the UE (100) not in NR due to voice fallback.

In an embodiment, in the successful handover report (SHR), for a handover from EUTRA to NR due to return from voice fallback, the UE (100) logs an indication that the handover is due to return from voice fallback. In an embodiment, in the connection establishment failure report (CEF report) after a handover or a redirection from EUTRA to NR due to return from voice fallback, the UE (100) logs an indication that the handover is due to return from voice fallback. In an embodiment, in the radio link failure report (RLF report) after a handover or a redirection from E-UTRA to NR due to return from voice fallback, the UE (100) logs an indication that the radio link failure happened for a handover or redirection due to return from voice fallback.

In an embodiment, the UE (100) receives the indication from the network apparatus (200) (e.g., eNB or the like) that the handover from the E-UTRA to the NR is due to return to the NR from the voice fallback. The information is received in the RRC Release or the RRC Reconfiguration or any other LTE RRC message. The UE (100) logs the indication about return from the voice fallback using the received information.

An example specification extract from RRC spec TS 36.331 with the embodiment is given below:

| RRCConnectionRelease ::= | SEQUENCE { | |
|---|---|---|
| rrc-TransactionIdentifier | RRC-TransactionIdentifier, | |
| criticalExtensions | CHOICE { | |
| c1 | | CHOICE { |

| | |
|---|---|
| rrcConnectionRelease-r8 | RRCConnectionRelease- |

```
r8-IEs,
              spare3 NULL, spare2 NULL, spare1 NULL
          },
      }
  }
```

| | |
|---|---|
| RRCConnectionRelease-r8-IEs ::= | SEQUENCE { |
| releaseCause | , |
| redirectedCarrierInfo | RedirectedCarrierInfo |
| OPTIONAL, | -- Need ON |

idleModeMobilityControlInfo

| | |
|---|---|
| OPTIONAL, | -- Need OP |
| nonCriticalExtension | RRCConnectionRelease-v890-IEs |

```
      OPTIONAL
  }
```

| RRCConnectionRelease-v890-IEs ::= | SEQUENCE { | |
|---|---|---|
| lateNonCriticalExtension | OCTET STRING | (CONTAINING |

| | |
|---|---|
| RRCConnectionRelease-v9e0-IEs) | OPTIONAL, |
| nonCriticalExtension | RRCConnectionRelease-v920-IEs |

```
      OPTIONAL
  }
  ...............
```

| RRCConnectionRelease-v1650-IEs ::= | SEQUENCE { | |
|---|---|---|
| mpsPriorityIndication-r16 | ENUMERATED | {true} |

OPTIONAL, -- Cond Redirection2

| | |
|---|---|
| nonCriticalExtension | RRCConnectionRelease-v1810- |

```
  IEs OPTIONAL
  }
```

| RRCConnectionRelease-v1810-IEs ::= | SEQUENCE { | |
|---|---|---|
| returnFromVoiceFallback | ENUMERATED | {true} |

OPTIONAL,

| | |
|---|---|
| nonCriticalExtension | SEQUENCE{ } |

```
      OPTIONAL
  }
```

| RRCConnectionReconfiguration ::= | SEQUENCE { | |
|---|---|---|
| rrc-TransactionIdentifier | RRC-TransactionIdentifier, | |
| criticalExtensions | CHOICE { | |
| c1 | | CHOICE { |

| | |
|---|---|
| rrcConnectionReconfiguration-r8 | RRCConnectionReconfiguration- |

```
  r8-1Es,
              spare7 NULL,
              spare6 NULL, spare5 NULL, spare4 NULL,
              spare3 NULL, spare2 NULL, spare1 NULL
          },
```

| | |
|---|---|
| criticalExtensionsFuture | SEQUENCE { } |

```
      }
  }
  ......
  RRCConnectionReconfiguration-v1700-IEs ::= SEQUENCE {
```

| | | |
|---|---|---|
| systemInformationBlockType31Dedicated-r17 | OCTET | STRING |

(CONTAINING SystemInformationBlockType31-r17)

| | |
|---|---|
| OPTIONAL, | -- Cond HO-NTN |

scg-State-r17

| | |
|---|---|
| ENUMERATED {deactivated} | OPTIONAL, -- Need OP |

```
      nonCriticalExtension
      RRCConnectionReconfiguration-v1800-IEs { }
      OPTIONAL
  }
  RRCConnectionReconfiguration-v1800-IEs ::= SEQUENCE {
```

| | | |
|---|---|---|
| returnFromVoiceFallback | ENUMERATED | {true} |

OPTIONAL,

| | |
|---|---|
| nonCriticalExtension | SEQUENCE{ } |

```
      OPTIONAL
  }
```

In an embodiment, the UE (100) logs the indication about return from voice fallback in NR SHR/RLF/CEF based on whether the UE (100) had performed voice fallback to E-UTRA from NR and has received RRC Release or MobilityFrom E-UTRA for handover to NR after the voice call is finished.

In an embodiment, if the UE (100) has successful Inter-RAT handover information available in Inter-RAT successful handover report and if the RPLMN is included in plmn-IdentityList stored in Inter-RAT successful handover report, the UE (100) includes an indication that Inter RAT successful handover report (information) is available in RRC Setup Complete message or RRC Resume Complete message or RRC Reestablishment Complete message.

In an embodiment, if the UE has successful Inter-RAT handover information available in Inter-RAT successful handover report and if the registered SNPN is included in npn-IdentityInfoList stored in Inter-RAT successful handover report, the UE (100) includes an indication that Inter RAT successful handover report (information) is available in RRC Setup Complete message or RRC Resume Complete message or RRC Reestablishment Complete message.

In an embodiment, if the UE (100) has successful handover information available in successful handover report or radio link report or connection establishment failure report and if the registered SNPN is included in npn-Identity InfoList stored in successful handover report, the UE (100) includes an indication that successful handover report (information) or radio link failure report or connection establishment failure report is available in RRC Setup Complete message or RRC Resume Complete message or RRC Reestablishment Complete message.

In an embodiment, if the UE (100) has successful Inter-RAT redirection information for voice fallback available and if the RPLMN is included in plmn-IdentityList stored in report for Inter-RAT redirection information for voice fallback, the UE (100) includes an indication that Inter-RAT redirection information for voice fallback is available in RRC Setup Complete message or RRC Resume Complete message or RRC Reestablishment Complete message.

In an embodiment, if the UE (100) has successfulInter-RAT redirection information for voice fallback available and if the registered SNPN is included in npnIdentity InfoList stored in report for Inter-RAT redirection information for voice fallback, the UE (100) includes an indication that Inter-RAT redirection information for voice fallback is available in RRC Setup Complete message or RRC Resume Complete message or RRC Reestablishment Complete message.

In an embodiment, the UE (100) receives request to report successful Inter-RAT handover information or Inter-RAT redirection information for voice fallback in a RRC message like UE Information Request. In an embodiment, the UE (100) reports successful Inter-RAT handover information or Inter-RAT redirection information for voice fallback in a RRC message like UE Information Response.

FIG. 2 shows various hardware components of the UE (100), according to the embodiments as disclosed herein. In an embodiment, the UE (100) includes a processor (110), a communicator (120), a memory (130) and a self-optimization controller (140). The processor (110) is coupled with the communicator (120), the memory (130) and the self-optimization controller (140). However, the components of the UE (100) are not limited thereto. For example, the UE (100) may include more or fewer components than those described above. In addition, the UE (100) corresponds to the UE of the FIG. 14. The self-optimization controller (140) may be included in the processor (110) or may be located separately from the processor (110). Also, the processor (110) may perform the operation of the feature specific self-optimization controller (140).

The self-optimization controller (140) receives the first RRC message. Further, the self-optimization controller (140) receives the mobility command for the inter-RAT handover. Upon receiving the mobility command, the self-optimization controller (140) triggers the inter-RAT handover from the source RAT to the target RAT in the wireless network (1000). Further, the self-optimization controller (140) determines whether at least one of the first RRC message includes at least one threshold for the SHR for the inter-RAT handover', and the mobility command includes at least one of the at least one threshold for the SHR for the inter-RAT handover, and the voice fallback indication'.

Further, the self-optimization controller (140) detects whether the threshold configured for the SHR for the inter-RAT handover is satisfied when at least one of the first RRC message comprises the threshold for the SHR and the mobility command comprises the at least one threshold for the SHR for the inter-RAT handover, and logs or skips logging of the SHR for the inter-RAT handover when the threshold configured for the SHR for the inter-RAT handover is satisfied.

In an embodiment, the self-optimization controller (140) determine whether the source RAT is the NR or the E-UTRA, or UTRA and the target RAT is the NR or the E-UTRA, or the UTRA. The self-optimization controller (140) logs the SHR for the inter-RAT handover when the source RAT is the NR and the target RAT is the EUTRA or when the source RAT is the E-UTRA and the target RAT is the NR. Alternatively, the self-optimization controller (140) skips log of the SHR when the source-RAT is the NR and the target RAT is the UTRA or when the source RAT is the UTRA and the target RAT is the NR. In an embodiment, the SHR for the inter-RAT handover is logged by storing at least one of a PLMN identifier or a SNPN identifier, a cell identifier of a source cell and a target cell, measurement results of source NR cell and inter-RAT and intra-RAT neighbours, random access related information, location information, user plane interruption information, a C-RNTI in the source cell and a C-RNTI in the target cell, and a time taken for performing the inter-RAT handover. In another embodiment, logging the SHR for the inter-RAT handover is skipped when the mobility command is received while the NR timer T316 is running.

Further, the self-optimization controller (140) detects the RLF during or after performing the inter-RAT handover when the mobility command comprises the voice fallback indication, and logs the indicator indicating the mobility is for the voice fallback in the RLF report for the RLF during or after performing the inter-RAT handover.

In an embodiment, the self-optimization controller (140) receives the UE capability request message from the network apparatus (200). Further, the self-optimization controller (140) sends the UE capability response message to the network apparatus (200). The UE capability response message includes at least one of: the support of the UE (100) for storage and delivery of the SHR for the inter-RAT handover from at least one of the NR to the E-UTRA and the E-UTRA to the NR, and the support of the UE (100) for storing and reporting information about the voice fallback.

In an embodiment, the self-optimization controller (140) sends at least one of an indication of availability of the SHR for the inter-RAT handover when at least one of the first RRC message comprises the threshold for the SHR and the mobility command comprises the at least one threshold for the SHR for the inter-RAT handover or an indication of availability of the RLF report when the mobility command comprises the voice fallback indication.

In an embodiment, the self-optimization controller (140) releases the threshold for the SHR for the inter-RAT handover during at least one of an initiation of RRC connection Resume procedure, and an initiation of RRC Reestablishment procedure.

The self-optimization controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the (100) may include less or more number of components. Further, the labels or names of the components are used only for illustrative purpose and does not limit the scope of the invention. One or more components can be combined together to perform same or substantially similar function in the (100).

FIG. 3 shows various hardware components of the network apparatus (200), according to the embodiments as disclosed herein. In an embodiment, the network apparatus (200) includes a processor (210), a communicator (220), a memory (230) and a self-optimization controller (140). The processor (210) is coupled with the communicator (220), the memory (230) and the self-optimization controller (240). However, the components of the network apparatus (200) are not limited thereto. For example, network apparatus (200) may include more or fewer components than those described above. In addition, the network apparatus (200) corresponds to the base station of the FIG. 15. The self-optimization controller (240) may be included in the processor (210) or may be located separately from the processor (210). Also, the processor (210) may perform the operation of the feature specific self-optimization controller (240).

The self-optimization controller (240) sends the first RRC message to the UE (100). The first RRC message includes the threshold for the SHR for the inter-RAT handover. The SHR includes at least one of the PLMN identifier or the SNPN identifier, the cell identifier of the source cell and the target cell, the measurement results of the source NR cell and the inter-RAT and intra-RAT neighbours, the random access related information, the location information, the user plane interruption information, the C-RNTI in the source and the target cells, and a time taken for performing the intra-RAT handover. Further, the self-optimization controller (240) sends the mobility command for the inter-RAT handover to the UE (100). The mobility command includes at least one of the threshold for the SHR for the inter-RAT handover, and the voice fallback indication. Further, the self-optimization controller (240) receives at least one of the indication of availability of the SHR for the inter-RAT handover from the UE (100), when at least one of the first RRC message comprises the threshold for the SHR and the mobility command comprises the at least one threshold for the SHR for the inter-RAT handover or the indication of availability of the RLF report from the UE (100) when the mobility command includes the voice fallback indication. The RLF report includes an indicator indicating a RLF occurred during or after performing for the inter-RAT handover.

Further, the self-optimization controller (240) sends the UE information request message to the UE (100). Further, the self-optimization controller (240) receives the UE information response message from the UE (100), where the UE information response message includes at least one of the SHR for the inter-RAT handover or the RLF report including information about the voice fallback for the inter-RAT handover.

Further, the self-optimization controller (240) sends the UE capability request message to the UE (100). Further, the self-optimization controller (240) receives a UE capability response message from the UE (100), where the UE capability response message includes at least one of: a support of the UE (100) for storage and delivery of the SHR for at least one of the inter-RAT handover from at least one of a NR to an EUTRA and the E-UTRA to the NR, and a support of the UE (100) for storing and reporting information about the voice fallback.

The self-optimization controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the network apparatus (200) but it is to be understood that other embodiments are not limited thereon. In other embodiments, the network apparatus (200) may include less or more number of components. Further, the labels or names of the components are used only for illustrative purpose and does not limit the scope of the invention. One or more components can be combined together to perform same or substantially similar function in the network apparatus (200).

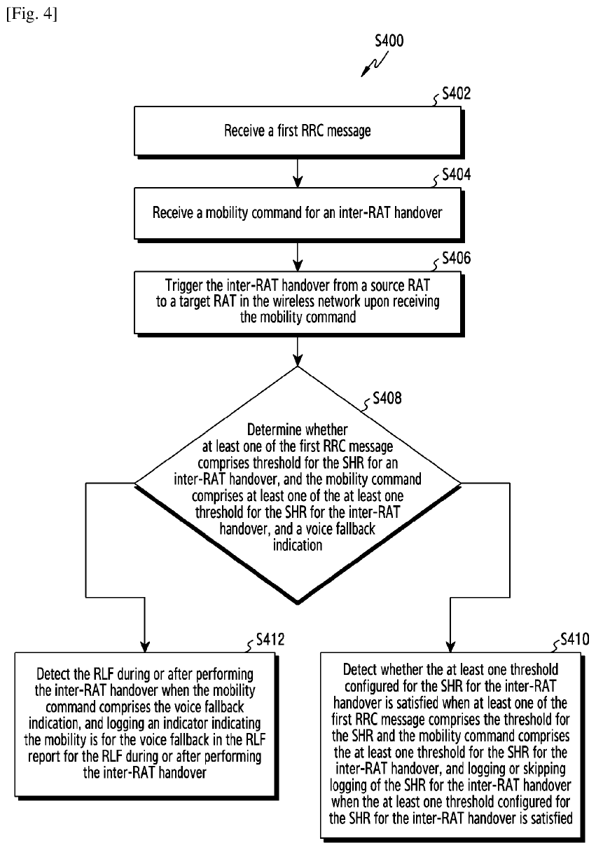

FIG. 4 is a flow chart (S400) illustrating a method, implemented by the UE (100), for self-optimization in the wireless network (1000), according to the embodiments as disclosed herein. The operations (S402-S412) are handled by the self-optimization controller (140).

At step S402, the method includes receiving the first RRC message. At step S404, the method includes receiving the mobility command for the inter-RAT handover. At step S406, the method includes triggering the inter-RAT handover from the source RAT to the target RAT in the wireless network (1000) upon receiving the mobility command. At step S408, the method includes determining whether at least one of the first RRC message includes the threshold for the SHR for the inter-RAT handover', and the mobility command includes at least one of the threshold for the SHR for the inter-RAT handover, and the voice fallback indication'. In an embodiment, at step S410, the method includes detecting whether the threshold configured for the SHR for the inter-RAT handover is satisfied when at least one of the first RRC message includes the threshold for the SHR and the mobility command includes the threshold for the SHR for the inter-RAT handover, and logging or skipping logging of the SHR for the inter-RAT handover when the threshold configured for the SHR for the inter-RAT handover is satisfied. In another embodiment, at step S412, the method includes detecting the RLF during or after performing the inter-RAT handover when the mobility command includes the voice fallback Indication, and logging the indicator indicating the mobility is for the voice fallback in the RLF report for the RLF during or after performing the inter-RAT handover.

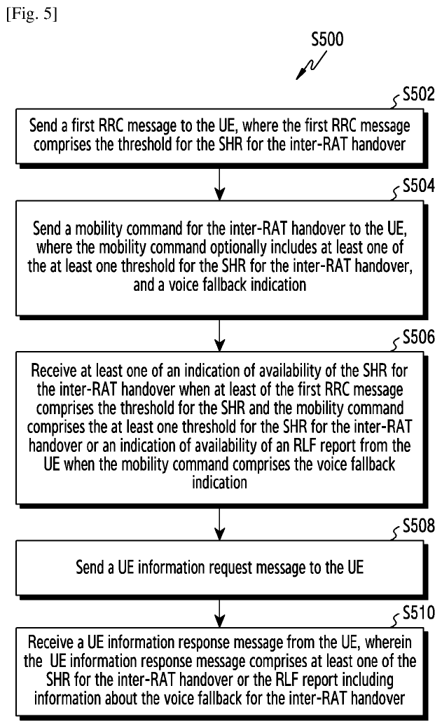

FIG. 5 is a flow chart (S500) illustrating a method, implemented by the network apparatus (200), for self-optimization in the wireless network (1000), according to the embodiments as disclosed herein. The operations (S502-S510) are handled by the self-optimization controller (240).

At step S502, the method includes sending the first RRC message to the UE. The first RRC message includes the threshold for the SHR for the inter-RAT handover. At step S504, the method includes sending the mobility command for the inter-RAT handover to the UE. The mobility command includes at least one of the threshold for the SHR for the inter-RAT handover, and the voice fallback indication. At step S506, the method includes receiving, by the network apparatus (200) from the UE (100), at least one of the indication of availability of the SHR for the inter-RAT handover when at least one of the first RRC message includes the threshold for the SHR and the mobility command includes the threshold for the SHR for the inter-RAT handover or an indication of availability of the RLF report from the UE (100) when the mobility command includes the voice fallback indication. At step S508, the method includes sending the UE information request message to the UE (100). At step S510, the method includes receiving the UE information response message from the UE (100). The UE information response message includes at least one of the SHR for the inter-RAT handover or the RLF report including information about the voice fallback for the inter-RAT handover.

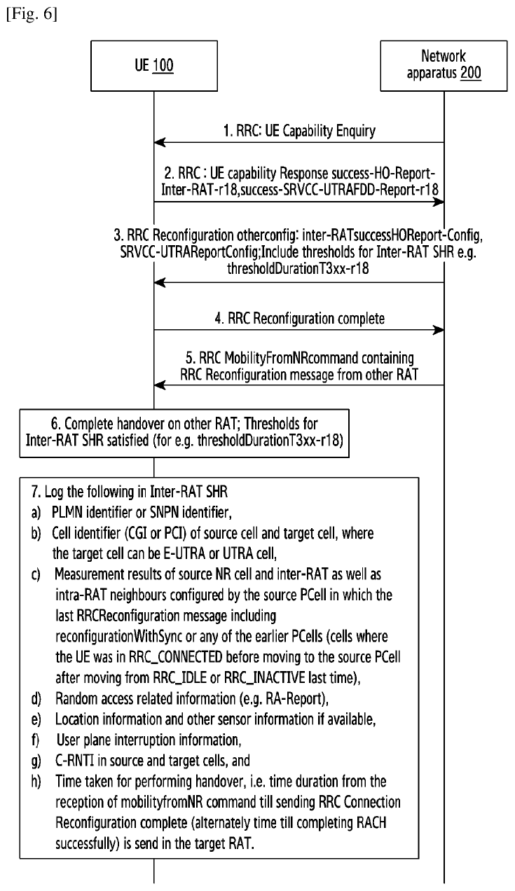

FIG. 6 is a sequence diagram illustrating a step by step operation of the inter-RAT SHR reporting, according to the embodiments as disclosed herein.

At step 1, the network apparatus (200) sends the RRC: UE capability enquiry to the UE (100). At step 2, the UE (100) sends the RRC: UE capability Response successHO-Report-Inter-RAT-r18, success-SRVCC-UTRAFDD-Report-r18 to the network apparatus (200). At step 3, the network apparatus (200) sends the RRC Reconfiguration otherconfig: inter-RATsuccessHOReport-Config, SRVCCUTRAReportConfig; Include thresholds for Inter-RAT SHR e.g. thresholdDurationT3 xx-r18 to the UE (100). At step 4, the UE (100) sends the RRC Reconfiguration complete to the network apparatus (200). At step 5, the network apparatus (200) sends the RRC MobilityFromNRcommand containing RRC Reconfiguration message from other RAT to the UE (100)

At step 6, the UE (100) determines the complete handover on other RAT and the thresholds for Inter-RAT SHR satisfied (for e.g. thresholdDurationT3xx-r18). At step 7, the UE (100) logs the following in Inter-RAT SHR such as a) PLMN identifier or SNPN identifier, b) the cell identifier (CGI or PCI) of the source cell and the target cell, where the target cell can be E-UTRA or UTRA cell, c) logs the measurement results of source NR cell and inter-RAT as well as intra-RAT neighbors configured by the source PCell in which the last RRCReconfiguration message including reconfiguration WithSync or any of the earlier PCells (cells where the UE (100) was in the RRC_CONNECTED before moving to the source PCell after moving from RRC_IDLE or RRC_INACTIVE last time), d) Random access related information (e.g. RA-Report), e) the location information and other sensor information if available, f) logs the user plane interruption information, g) C-RNTI in source and target cells, and h) time taken for performing handover, i.e. time duration from the reception of mobilityfromNR command till sending RRC Connection Reconfiguration complete (alternately time till completing RACH successfully) is send in the target RAT.

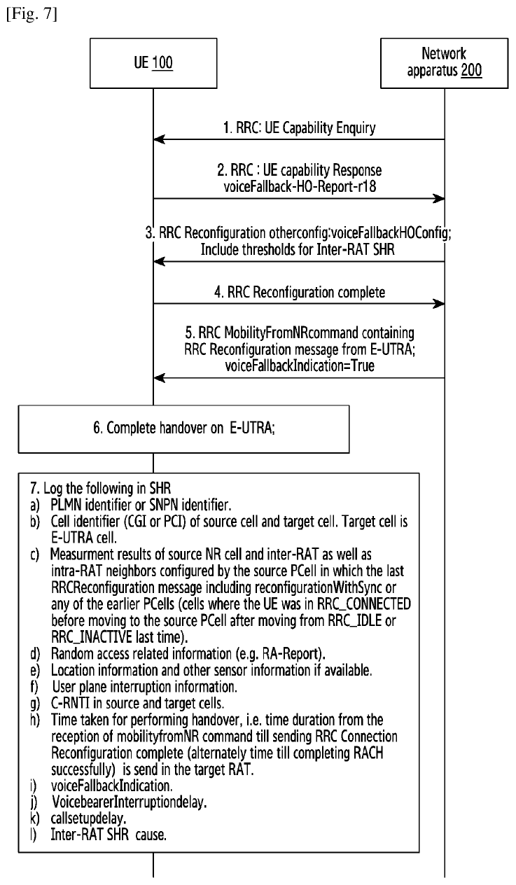

FIG. 7 is a sequence diagram illustrating a step by step operation the voice fallback indication in a SHR reporting, according to the embodiments as disclosed herein.

At step 1, the network apparatus (200) sends the RRC: UE capability enquiry to the UE (100). At step 2, the UE (100) sends the RRC: UE capability response voiceFallback-HO-Report-r18 to the network apparatus (200). At step 3, network apparatus (200) sends the RRC reconfiguration otherconfig: voiceFallbackHOConfig; including the thresholds for Inter-RAT SHR to the UE (100). At step 4, the UE (100) sends the RRC Reconfiguration complete to the network apparatus (200). At step 5, the network apparatus (200) sends the RRC MobilityFromNRcommand containing RRC Reconfiguration message from E-UTRA and the voiceFallbackIndication=True to the UE (100). At step 6, the UE (100) completes the handover on the E-UTRA.

At step 7, the UE (100) logs the following in SHR such as a) PLMN identifier or SNPN identifier, b) cell identifier (CGI or PCI) of source cell and target cell. Where the target cell is E-UTRA cell, c) measurement results of source NR cell and inter-RAT as well as intra-RAT neighbors configured by the source PCell in which the last RRCReconfiguration message including reconfigurationWithSync or any of the earlier Pcells (cells where the UE (100) was in RRC_CONNECTED before moving to the source Pcell after moving from RRC_IDLE or RRC_INACTIVE last time), d) random access related information (e.g. RA-Report), e) location information and other sensor information if available, f) User plane interruption information, g) C-RNTI in source and target cells, h) time taken for performing handover, i.e. time duration from the reception of mobilityfromNR command till sending RRC Connection Reconfiguration complete (alternately time till completing RACH successfully) is send in the target RAT, i) voiceFallbackIndication, j) voicebearerInterruptiondelay, k, callsetupdelay, and l) Inter-RAT SHR cause.

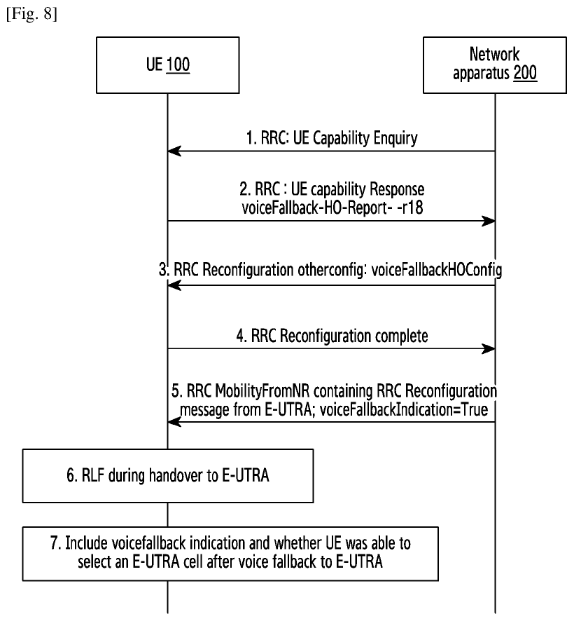

FIG. 8 is a sequence diagram illustrating a step by step operation a voice fallback indication RLF reporting, according to the embodiments as disclosed herein.

At step 1, the network apparatus (200) sends the RRC: UE capability enquiry to the UE (100). At step 2, the UE (100) sends the RRC: UE capability response voiceFallback-HO-Report-r18 to the network apparatus (200). At step 3, network apparatus (200) sends the RRC reconfiguration otherconfig: voiceFallbackHOConfig to the UE (100). At step 4, the UE (100) sends the RRC Reconfiguration complete to the network apparatus (200). At step 5, the network apparatus (200) sends the RRC MobilityFromNR containing RRC Reconfiguration message from the E-UTRA and the voiceFallbackIndication=True to the UE (100). At step 6, the UE (100) performs the RLF during handover to the E-UTRA. At step 7, the UE (100) includes the voice fallback indication and whether the UE (100) is able to select the E-UTRA cell after voice fallback to the E-UTRA.

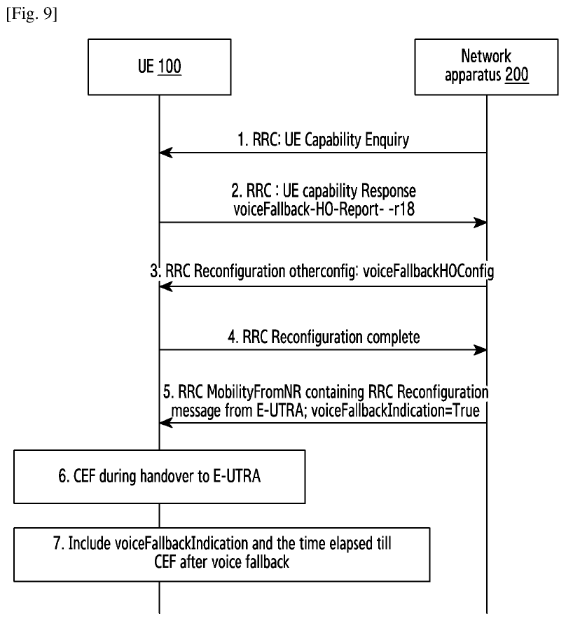

FIG. 9 is a sequence diagram illustrating a step by step operation a voice fallback indication CEF reporting, according to the embodiments as disclosed herein.

At step 1, the network apparatus (200) sends the RRC: UE capability enquiry to the UE (100). At step 2, the UE (100) sends the RRC: UE capability response voiceFallback-HO-Report-r18 to the network apparatus (200). At step 3, network apparatus (200) sends the RRC reconfiguration otherconfig: voiceFallbackHOConfig to the UE (100). At step 4, the UE (100) sends the RRC Reconfiguration complete to the network apparatus (200). At step 5, the network apparatus (200) sends the RRC MobilityFromNR containing the RRC Reconfiguration message from the E-UTRA and the voiceFallbackIndication=True to the UE (100). At step 6, the UE (100) performs the CEF during handover to the E-UTRA. At step 7, the UE (100) includes the voiceFallbackIndication and the time elapsed till the CEF after the voice fallback.

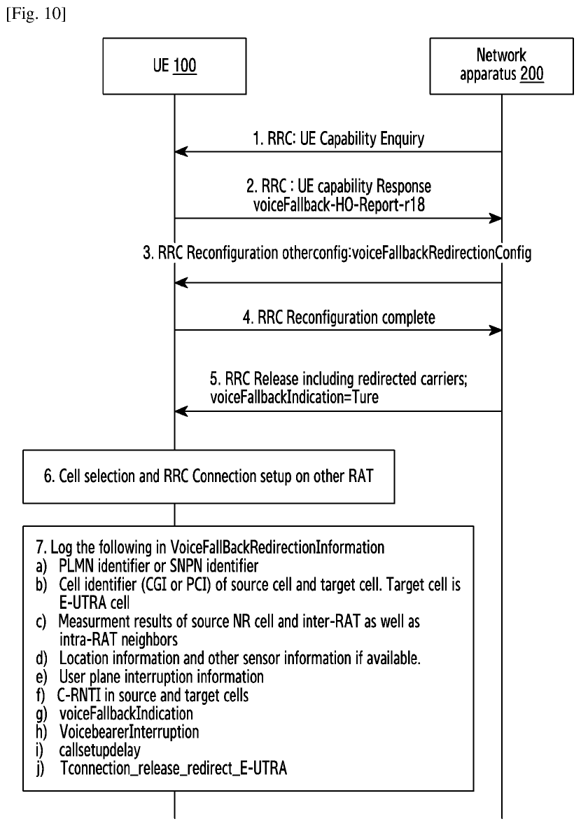

FIG. 10 is a sequence diagram illustrating a step by step operation a voicefall-backredirection reporting, according to the embodiments as disclosed herein.

At step 1, the network apparatus (200) sends the RRC: UE capability enquiry to the UE (100). At step 2, the UE (100) sends the RRC: UE capability response voiceFallback-Redirection-Report-r18 to the network apparatus (200). At step 3, network apparatus (200) sends the RRC reconfiguration otherconfig: voiceFallbackHOConfig to the UE (100). At step 4, the UE (100) sends the RRC Reconfiguration complete to the network apparatus (200). At step 5, the network apparatus (200) sends the RRC Release including redirected carriers and the voiceFallbackIndication=True to the UE (100). At step 6, the UE (100) performs the cell selection and the RRC connection setup on other RAT. At step 7, the UE (100) logs the following in VoiceFallBackRedirectionInformation such as a) PLMN identifier or SNPN identifier, b) cell identifier (CGI or PCI) of the source cell and the target cell, where the target cell is E-UTRA cell, c) the measurement results of source NR cell and inter-RAT as well as intra-RAT neighbors, d) location information and other sensor information if available, e) user plane interruption information, f) C-RNTI in source and target cells, g) voiceFallbackIndication, h) VoicebearerInterruption, i) callsetupdelay, and j) tconnection_release_redirect_E-UTRA.

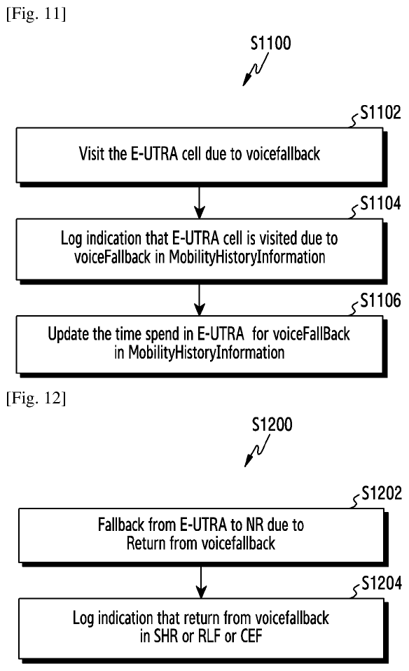

FIG. 11 is a flow chart (S1100) illustrating a method for handling of mobility information with voice fallback, while handling the self-optimization in the wireless network (1000), according to the embodiments as disclosed herein. The operations (S1102-S1106) are performed by the self-optimization controller (140).

At step S1102, the method includes visiting the E-UTRA cell due to the voice fallback. At step S1104, the method includes logging the indication that the E-UTRA cell is visited due to voiceFallback in the MobilityHistoryInformation. At step S1106, the method includes updating the time spend in the E-UTRA for voiceFallBack in the MobilityHistory Information.

FIG. 12 is a flow chart (S1200) illustrating a scenario of logging of return from voice fallback indication, while handling the self-optimization in the wireless network (1000), according to the embodiments as disclosed herein.

At step S1202, the method includes fall-backing from the E-UTRA to the NR due to return from the voice fallback. At step S1204, the method includes logging the indication that return from the voice fallback in the SHR or the RLF or the CEF.

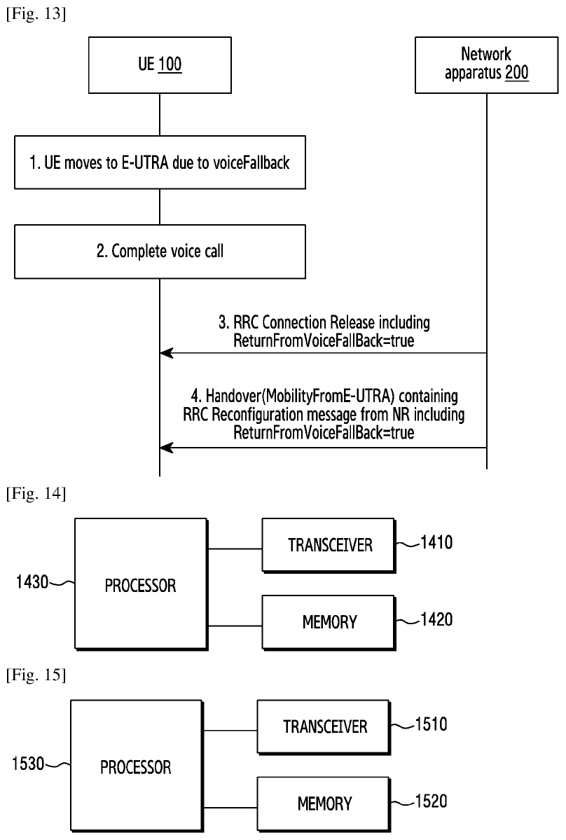

FIG. 13 is a sequence diagram illustrating a step by step operation of informing return from voice fallback to the UE, according to the embodiments as disclosed herein.

At step 1, the UE (100) moves to the E-UTRA due to the voiceFallback. At step 2, the UE (100) completes the voice call. At step 3, the network apparatus (200) sends the RRC connection release including the ReturnFrom VoiceFallBack=true to the UE (100). Alternatively, at step 4, the network apparatus (200) sends the handover (MobilityFromE-UTRA) containing the RRC Reconfiguration message from NR including ReturnFrom VoiceFallBack=true to the UE (100).

FIG. 14 illustrates a structure of a UE according to an embodiment of the disclosure.

As shown in FIG. 14, the UE according to an embodiment may include a transceiver 1410, a memory 1420, and a processor 1430. The transceiver 1410, the memory 1420, and the processor 1430 of the UE may operate according to a communication method of the UE described above. However, the components of the UE are not limited thereto. For example, the UE may include more or fewer components than those described above. In addition, the processor 1430, the transceiver 1410, and the memory 1420 may be implemented as a single chip. Also, the processor 1430 may include at least one processor. Furthermore, the UE of FIG. 14 corresponds to the UE (100) of the FIG. 2.

The transceiver 1410 collectively refers to a UE receiver and a UE transmitter, and may transmit/receive a signal to/from a base station or a network entity. The signal transmitted or received to or from the base station or a network entity may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the UE. Also, the memory 1420 may store control information or data included in a signal obtained by the UE. The memory 1420 may be a storage medium, such as read-only memory (ROM), random access memory (RAM), a hard disk, a CD-ROM, and a DVD, or a combination of storage media.

The processor 1430 may control a series of processes such that the UE operates as described above. For example, the transceiver 1410 may receive a data signal including a control signal transmitted by the base station or the network entity, and the processor 1430 may determine a result of receiving the control signal and the data signal transmitted by the base station or the network entity.

FIG. 15 illustrates a structure of a base station according to an embodiment of the disclosure.

As shown in FIG. 15, the base station according to an embodiment may include a transceiver 1510, a memory 1520, and a processor 1530. The transceiver 1510, the memory 1520, and the processor 1530 of the base station may operate according to a communication method of the base station described above. However, the components of the base station are not limited thereto. For example, the base station may include more or fewer components than those described above. In addition, the processor 1530, the transceiver 1510, and the memory 1520 may be implemented as a single chip. Also, the processor 1530 may include at least one processor. Furthermore, the base station of FIG. 15 corresponds to the network apparatus (200) of the FIG. 3.

The transceiver 1510 collectively refers to a base station receiver and a base station transmitter, and may transmit/receive a signal to/from a terminal (UE) or a network entity. The signal transmitted or received to or from the terminal or a network entity may include control information and data. The transceiver 1510 may include a RF transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the base station. Also, the memory 1520 may store control information or data included in a signal obtained by the base station. The memory 1520 may be a storage medium, such as read-only memory (ROM), random access memory (RAM), a hard disk, a CD-ROM, and a DVD, or a combination of storage media.

The processor 1530 may control a series of processes such that the base station operates as described above. For example, the transceiver 1510 may receive a data signal including a control signal transmitted by the terminal, and the processor 1530 may determine a result of receiving the control signal and the data signal transmitted by the terminal.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1-15. (canceled)

16. A method performed by a user equipment (UE) in a wireless communication system, the method comprising:
receiving, from a source base station, a configuration including information for an inter radio access technology (RAT) handover from the source base station of a first RAT to a target base station of a second RAT, wherein the information is related to at least one of a timer t310 or a timer t312;
generating information on a successful handover based on the at least one of the timer t310 or the timer t312, in case that the inter RAT handover is successfully completed; and
transmitting, to the source base station, the information on the successful handover,
wherein the first RAT is a new radio (NR), and the second RAT is a long term evolution (LTE).

17. The method of claim 16, wherein the information on the successful handover is included in a UE information response message corresponding to a UE information request message received from the source base station.

18. The method of claim 16, wherein the information on the successful handover includes at least one of public land mobile network (PLMN) identity, standalone non-public network (SNPN) identity, cell information on the source base station, a measurement result for the source base station, cell information on the target base station, a measurement result for the target base station, a measurement result for a neighbor base station, cause information indicating the at least one of the timer t310 or the timer t312 that triggering condition is met, a cell radio network temporary identifier (C-RNTI) of the source base station, or a C-RNTI of the target base station.

19. The method of claim 16, further comprising:
transmitting, to the source base station, a radio link failure (RLF) report including first information indicating a failure of the inter RAT handover for a voice fallback.

20. The method of claim 19, wherein second information indicating the voice fallback is included in a message for command the inter RAT handover.

21. A method performed by a source base station of a first radio access technology (RAT) in a wireless communication system, the method comprising:
transmitting, to a user equipment (UE), a configuration including information for an inter radio access technology (RAT) handover from the source base station of a first RAT to a target base station of a second RAT, wherein the information is related to at least one of a timer t310 or a timer t312; and
receiving, from the UE, information on a successful handover,
wherein the information on the successful handover is based on the at least one of the timer t310 or the timer t312, and
wherein the first RAT is a new radio (NR), and the second RAT is a long term evolution (LTE).

22. The method of claim 21, wherein the information on the successful handover is included in a UE information response message corresponding to a UE information request message received from the source base station.

23. The method of claim 21, wherein the information on the successful handover includes at least one of public land mobile network (PLMN) identity, standalone non-public network (SNPN) identity, cell information on the source base station, a measurement result for the source base station, cell information on the target base station, a measurement result for the target base station, a measurement result for a neighbor base station, cause information indicating the at least one of the timer t310 or the timer t312 that triggering condition is met, a cell radio network temporary identifier (C-RNTI) of the source base station, or a C-RNTI of the target base station.

24. The method of claim 21, further comprising:
receiving, from the UE, a radio link failure (RLF) report including information indicating a failure of the inter RAT handover for a voice fallback.

25. The method of claim 24, wherein second information indicating the voice fallback is included in a message for command the inter RAT handover.

26. A user equipment (UE) in a wireless communication system, the UE comprising:
a transceiver; and
at least one processor coupled with the transceiver and configured to:
receive, from a source base station, a configuration including information for an inter radio access technology (RAT) handover from the source base station of a first RAT to a target base station of a second RAT, wherein the information is related to at least one of a timer t310 or a timer t312,
generate information on a successful handover based on the at least one of the timer t310 or the timer t312, in case that the inter RAT handover is successfully completed, and
transmit, to the source base station, the information on the successful handover,
wherein the first RAT is a new radio (NR), and the second RAT is a long term evolution (LTE).

27. The UE of claim 26, wherein the information on the successful handover is included in a UE information response message corresponding to a UE information request message received from the source base station.

28. The UE of claim 26, wherein the information on the successful handover includes at least one of public land mobile network (PLMN) identity, standalone non-public network (SNPN) identity, cell information on the source base station, a measurement result for the source base station, cell information on the target base station, a measurement result for the target base station, a measurement result for a neighbor base station, cause information indicating the at least one of the timer t310 or the timer t312 that triggering condition is met, a cell radio network temporary identifier (C-RNTI) of the source base station, or a C-RNTI of the target base station.

29. The UE of claim 26, wherein the at least one processor is further configured to transmit, to the source base station, a radio link failure (RLF) report including information indicating a failure of the inter RAT handover for a voice fallback.

30. The UE of claim 29, wherein second information indicating the voice fallback is included in a message for command the inter RAT handover.

31. A source base station of a first radio access technology (RAT) in a wireless communication system, the source base station comprising:
a transceiver; and
at least one processor coupled with the transceiver and configured to:
transmit, to a user equipment (UE), a configuration including information for an inter radio access technology (RAT) handover from the source base station of a first RAT to a target base station of a second RAT, wherein the information is related to at least one of a timer t310 or a timer t312, and
receive, from the UE, information on a successful handover,
wherein the information on the successful handover is based on the at least one of the timer t310 or the timer t312, and
wherein the first RAT is a new radio (NR), and the second RAT is a long term evolution (LTE).

32. The source base station of the first RAT of claim 31, wherein the information on the successful handover is included in a UE information response message corresponding to a UE information request message received from the source base station.

33. The source base station of the first RAT of claim 31, wherein the information on the successful handover includes at least one of public land mobile network (PLMN) identity, standalone non-public network (SNPN) identity, cell information on the source base station, a measurement result for the source base station, cell information on the target base station, a measurement result for the target base station, a measurement result for a neighbor base station, cause information indicating the at least one of the timer t310 or the timer t312 that triggering condition is met, a cell radio network temporary identifier (C-RNTI) of the source base station, or a C-RNTI of the target base station.

34. The source base station of the first RAT of claim 31, wherein the at least one processor is further configured to receive, from the UE, a radio link failure (RLF) report including information indicating a failure of the inter RAT handover for a voice fallback.

35. The source base station of the first RAT of claim 34, wherein second information indicating the voice fallback is included in a message for command the inter RAT handover.
